(19) United States
(12) Patent Application Publication
(10) Pub. No.: US 2020/0184845 A1
(43) Pub. Date: Jun. 11, 2020

(54) Data control system for a data server and a plurality of cellular phones, a data server for the system, and a cellular phone for the system

(71) Applicant: Masahide Tanaka, Osaka (JP)

(72) Inventor: Masahide Tanaka, Osaka (JP)

(73) Assignee: NL Giken Incorporated, Osaka (JP)

(21) Appl. No.: 16/792,294

(22) Filed: Feb. 16, 2020

Related U.S. Application Data
(63) Continuation-in-part of application No. 16/370,998, filed on Mar. 31, 2019.

(30) Foreign Application Priority Data
Mar. 31, 2018 (JP) 2018-070485
Mar. 31, 2018 (JP) 2018-070488
Mar. 31, 2018 (JP) 2018-070497
Feb. 18, 2019 (JP) 2019-026917

(51) Int. Cl. G09B 19/00; H04M 1/725; G06K 9/46; G10L 17/00; G06K 9/00; H04R 5/033; H04S 3/00; H04R 25/00

(52) U.S. Cl. CPC G09B 19/00; H04M 1/7253; G06K 9/46; G10L 17/005; G06K 9/00268; H04R 2225/55; H04S 3/008; H04R 25/55; G06K 2209/01; H04S 2400/01; H04R 5/033

(57) ABSTRACT

A data control system comprises a user terminal such as a cellular phone, or an assist appliance, or a combination thereof, and a server in communication with the user terminal. The user terminal acquires the name of a person and an identification data of the person for storage as a reference on an opportunity of the first meeting with the person, and acquires the identification data of the person on an opportunity of meeting again to inform the name of the person with visual and/or audio display if the identification data is in consistency with the stored reference. The reference is transmitted to a server which allows another person to receive the reference on the condition that the same person has given a self-introduction both to a user of the user terminal and the another person to keep privacy of the same person against unknown persons.

### CROSS REFERENCE TO RELATED APPLICATION

This application is a Continuation-In-Part Application of U.S. application Ser. No. 16/370,998 filed Mar. 31, 2019, herein incorporated by reference in its entirety.

### BACKGROUND OF THE INVENTION

### 1. Field of the Invention

This invention relates to a data control system for a data server and a plurality of cellular phones, a data server for the system, and a cellular phone for the system. This invention further relates to a system for personal identification, especially to a system for assisting cognitive faculty of an elderly person or a demented patient, assist appliance, a cellular phone, and a personal identification server.

### 2. Description of the Related Art

In the field of personal identification or personal authentication, for example, various attempts have been done. For example, Japanese Publication No. 2010-061265 proposes spectacles including a visual line sensor, a face detection camera, and a projector for overlapping an information image on an image observed through the lens for display, in which face detection is operated in the image photographed by the face detection camera, and when it is detected that the face has been gazed from the visual line detection result, the pertinent records are retrieved by a sever device by using the face image. According to the proposed spectacles, when there does not exist any pertinent record, new records are created from the face image and attribute information decided from it and stored, and when there exist pertinent records, person information to be displayed is extracted from the pertinent records, and displayed by the projector.

On the other hand, Japanese Publication No. 2016-136299 proposes a voiceprint authentication to implement a voice change of the voice uttered by the user according to a randomly selected voice change logic, to transmit a voice subjected to the voice change from user terminal to the authentication server so that the authentication server implements the voice change of a registered voice of the user according to the same voice change logic and implements voiceprint authentication with cross reference to a post-voice changed voice from the user terminal.

However, there still exist in this field of art many demands for improvements of a system for assisting cognitive faculty, assist appliance, a cellular phone, a personal identification server, and a system including a cellular phone and a server cooperating therewith.

### SUMMARY OF THE INVENTION

Preferred embodiment of this invention provides a data control system for a data server and a plurality of cellular phones, a data server for the system, and a cellular phone for the system. For example, the data control system according to the preferred embodiment relates to a relationship between tentative identification data optionally attached to data by each cellular phone and a controlled identification data attached to the data under control of the data server, and to data delivery from the server with privacy of the data kept. Typical example of the data is name, face and voice print of a person.

In detail, for example, the mobile user terminal includes a terminal memory of names of persons and identification data for identifying the persons corresponding to the names as reference data; a first acquisition unit of the name of a person for storage in the memory, wherein the first acquisition unit acquires the name of the person on an opportunity of the first meeting with the person; a second acquisition unit of identification date of the person for storage in the memory, wherein the first acquisition unit acquires the identification data of the person as the reference data on the opportunity of the first meeting with the person, and acquires the identification data of the person on an opportunity of meeting again with the person; an assisting controller that compares the reference data with the identification data of the person acquired by the second acquisition unit on the opportunity of meeting again with the person to identify the name of the person if the comparison results in consistency; a display of the name of the person identified by the assisting controller in case a user of the mobile user terminal hardly reminds the name of the person on the opportunity of meeting again with the person; and a terminal communicator that transmits the identification data of the person corresponding to the name of the person as reference data, and receives for storage the identification data of the person corresponding to the name of the person as reference data which has been acquired by another mobile user terminal.

On the other hand the server includes a server memory of identification data of persons corresponding to the names as reference data; and a server communicator that receives the identification data of the person corresponding to the name of the person as reference data from the mobile user terminal for storage, and transmit the identification data of the person corresponding to the name of the person as reference data to another mobile user terminal for sharing the identification data of the same person corresponding to the name of the same person between the mobile user terminals for the purpose of increasing accuracy and efficiency of the personal identification.

According to a detailed feature of the preferred embodiment of this invention, the first acquisition unit includes an acquisition unit of voice print of a person, and in more detail, the first acquisition unit includes a microphone to pick up real voice of the person including the voice print, or a phone function on which voice of the person including the voice print is received.

According to another detailed feature of the embodiment of this invention, the first acquisition unit includes an acquisition unit of face features of a person, and in more detail, the acquisition unit of face features of the person a camera to capture a real face of the person including face features of the person, or a video phone function on which image of face of the person including the face features is received.

According to still another detailed feature of the embodiment of this invention, the second acquisition unit includes an optical character reader to read characters of the name of a person, or an extraction unit to extract name information from a voice of a person as the linguistic information.

According to another detailed feature of the embodiment of this invention, the display includes a visual display and/or an audio display. In more detail, the mobile user terminal further includes a microphone to pick up a voice of the person, and wherein the audio display audibly outputs the name of the person during a blank period of conversation when the voice of the person is not picked up by the microphone. Or, the audio display includes a stereo earphone, and wherein the audio display audibly outputs the name of the person only from one of a pair of channels of stereo earphone.

Further, according to another detailed feature of the embodiment of this invention, the mobile user terminal includes a cellular phone, or an assist appliance, or a combination of a cellular phone and assist appliance. An example of the assist appliance is a hearing aid, or spectacle having visual display.

Still further, according to another detailed feature of the embodiment of this invention, the server further including a reference data controller that allows the server communicator to transmit the identification data of the person corresponding to the name of the same person as reference data, which has been received from a first user terminal, to a second user terminal on the condition that the same person has given a self-introduction both to a user of the first user terminal and a user of the second user terminal to keep privacy of the same person against unknown persons. In more detail, the reference data controller is configured to allow the server communicator to transmit the identification data of the person corresponding to the name of the same person as a personal identification code without disclosing the real name of the person.

Other features, elements, arrangements, steps, characteristics and advantages according to this invention will be readily understood from the detailed description of the preferred embodiment in conjunction with the accompanying drawings.

The above description should not be deemed to limit the scope of this invention, which should be properly determined on the basis of the attached claims.

### BRIEF DESCRIPTION OF THE DRAWINGS

FIG. 1 is a block diagram of an embodiment of the present invention, in which a total system for assisting cognitive faculty of an elderly person or a demented patient is shown, the system including assist appliance of cognitive faculty, cellular phone, and personal identification server.

FIG. 2 is a table showing data structure and data sample of reference voice print data, reference face data and reference OCR data which are stored in voice print database, face database and OCR database of personal identification server, respectively.

FIG. 3 represents a block diagram of the embodiment of the present invention, in which the structure in the cellular phone is shown in more detail for the purpose of explaining a case that assist the appliance is omitted, for example, from the total system shown in FIG. 1.

FIG. 4 represents a basic flowchart showing the function of the phone controller of the cellular phone according to the embodiment shown in FIGS. 1 to 3.

FIG. 5 represents a flowchart showing the details of the parallel function of the assisting APP in step S24 in FIG. 4.

FIG. 6 represents a flowchart showing the details of the process of getting reference data of the conversation partner carried out in step S50 in FIG. 5.

FIG. 7 represents a flowchart showing the details of the process for getting own reference data carried out in step S48 in FIG. 5.

FIG. 8 represents a flowchart showing the details of the parallel function in cooperation with the personal identification server carried out in step S36 or S52 in FIG. 5.

FIG. 9 represents a flowchart showing the details of the cellular phone personal identification process in step S66 in FIG. 5 carried out by the cellular phone.

FIG. 10 represents a flowchart showing the details of the personal identification process under the paring condition in step S64 in FIG. 5 carried out by the cellular phone.

FIG. 11 represents a basic flowchart showing the function of the appliance controller of the assist appliance according to the embodiment shown in FIGS. 1 and 2.

FIG. 12 represents a basic flowchart showing the function of the server controller of the personal identification server according to the embodiment shown in FIGS. 1 and 3.

FIG. 13 represents a flowchart showing the details of the service providing process in steps S304, S310 and S314 in FIG. 12.

### DETAILED DESCRIPTION OF THE PREFERRED EMBODIMENTS

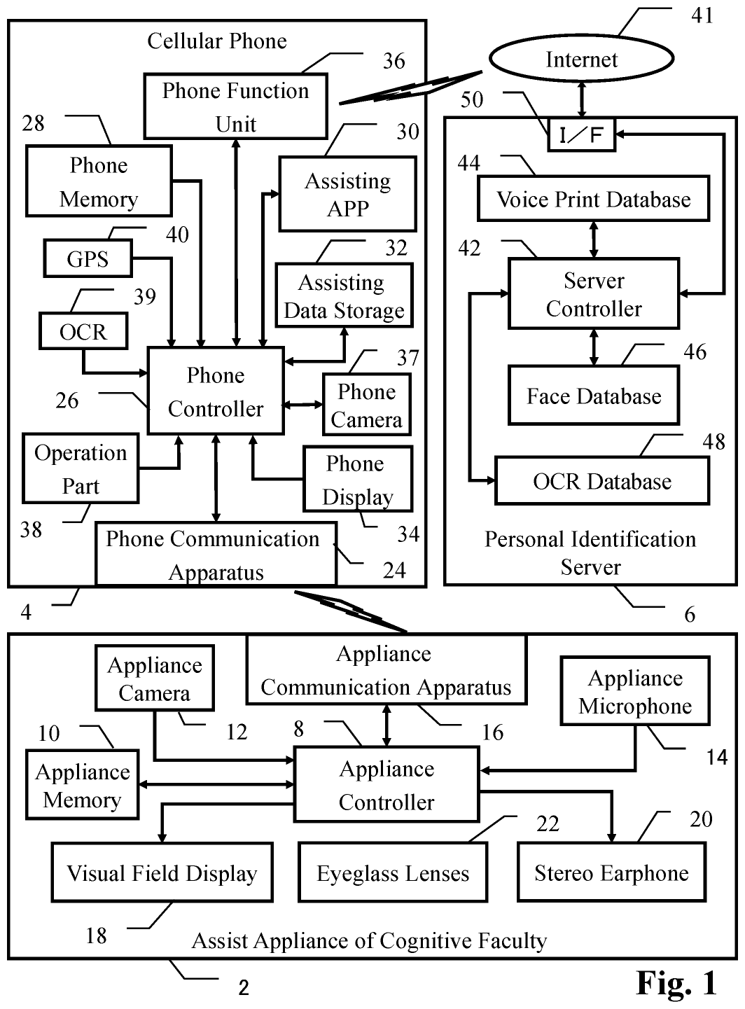

FIG. 1 represents a block diagram of an embodiment of the present invention, in which a total system for assisting cognitive faculty of an elderly person or a demented patient is shown. The system includes assist appliance 2 of cognitive faculty incorporated in spectacles with hearing aid, cellular phone 4 formed as a so-called “smartphone”, and personal identification server 6. Assist appliance 2 includes appliance controller 8 for controlling the entire assist appliance 2, and appliance memory 10 for storing appliance main program for functioning appliance controller 8 and for storing various data such as facial image data from appliance camera 12 and voice data from appliance microphone 14. Appliance controller 8 controls visual field display 18 for displaying visual image in the visual field of a user wearing assist appliance 2, the visual image being based on visual data received through appliance communication apparatus 16 capable of wireless short range communication. Appliance controller 8 further controls stereo earphone 20 for generating stereo sound in accordance with stereo audio data received through appliance communication apparatus 16.

Assist appliance 2 basically functions as an ordinary spectacles with a pair of eyeglass lenses 22, wherein visual field display 18 presents visual image in the real visual field viewed through eyeglass lenses 22 so that the visual image overlaps the real visual field. Assist appliance 2 also functions as an ordinary hearing aid which picks up surrounding sound such as voice of a conversation partner by means of appliance microphone 14, amplifies the picked up audio signal, and generates sound from stereo earphone 20 so that the use may hear the surrounding sound even if the user has poor hearing.

Assist appliance 2 further displays character representation such as a name of a conversation partner in the real visual field so that the character representation overlaps the real visual field, the character representation being a result of personal identification on the basis of facial image data gotten by appliance camera 12. For this purpose, appliance camera 12 is so arranged in assist appliance 2 to naturally cover the face of the conversation partner with its imaging area when the front side of the head of the user wearing the assist appliance 2 is oriented toward the conversation partner. Further, according to assist appliance 2, voice information of the name of a conversation partner is generated from one of the pair of channels of stereo earphone 20 as a result of personal identification on the basis of voice print analyzed on the basis of voice of the conversation partner gotten by appliance microphone 14. The result of personal identification on the basis of facial image data and the result of personal identification on the basis of voice print are cross-checked whether or not both the results identify the same person. If not, one of the results of higher probability is adopted as the final personal identification by means of a presumption algorithm in cognitive faculty assisting application program stored in application storage 30 explained later. Thus, a demented patient who cannot recall a name of an appearing acquaintance is assisted. Not only demented persons, but also elderly persons ordinarily feel difficulty in recalling a name of an appearing acquaintance. Assist appliance 2 according to the present invention widely assists the user as in the manner explained above to remove inferiority complex and keep sound sociability.

For the purpose of achieving the above mentioned cognitive assisting faculty, assist appliance 2 cooperates with cellular phone 4 and personal identification server 6. The facial image data and the voice data are read out form appliance memory 10 which stores the facial image data from appliance camera 12 and the voice data from appliance microphone 14. The data read out form appliance memory 10 are sent to phone communication apparatus 24 capable of wireless short range communication from appliance communication apparatus 16. In appliance communication apparatus 16 and phone communication apparatus 24, one of various wireless short range communication systems is applicable, such as wireless LAN (Local Area Network) or infrared communication system. Phone controller 26 has phone memory 28 store the received facial image data and the voice data. The data stored in phone memory 28 are to be compared with reference data stored in cognitive assisting data storage 32 to identify the conversation partner by means of phone controller 26 functioning in accordance with a processing program in cognitive faculty assisting application program stored in application storage 30 (hereinafter referred to as “assisting APP 30”). The data of the identification, such as name, of conversation partner is transmitted from phone communication apparatus 24 to communication apparatus 16. The transmitted identification data is displayed by visual field display 18 and audibly outputted from one of the pair of channels of stereo earphone 20 as explained above. The identification data such as name, of conversation partner is also displayed on phone display 34.

Phone controller 26, which functions in accordance with the phone main program stored in phone memory 28, is primarily for controlling entire cellular phone 4 including phone function unit 36 in ordinary manner, in addition to the control of the above mentioned cognitive assisting function. Manual operation part 38 and phone display 34, which are also primarily for operation and display relating to phone function unit 36, are utilized for the above mentioned cognitive assisting function. Further, phone camera 37 and phone microphone (not shown) within phone function unit 36, which in combination allow the video phone function, are also utilized for assisting cognitive faculty as will be explained later.

Cellular phone 4 further includes, primarily for controlling ordinary functions of entire cellular phone 4, global positioning system 40 (hereinafter referred to as “GPS 40”). According to the present invention, GPS 40 in combination with the function of phone controller 26 running on the processing program in assisting APP 30 is utilized for assisting cognitive faculty of the user by means of teaching the actual location of the user or directing the coming home route or a route to a visiting home or the like.

Optical character reader 39 (hereinafter referred to as “OCR 39”) of cellular phone 4 is to read a name from an image of a business card received from a conversation partner to convert into text data. The text data gotten by OCR 39 is to be stored into cognitive assisting data storage 32 so as to be tied up with the personal identification on the basis of the facial image data and the voice print. For this purpose, appliance camera 12 is so arranged to capture the image of the name on the business card which comes into the field of view of appliance camera 12 when the head of the user wearing assist appliance 2 faces the business card received from the conversation partner. And, appliance memory 10 once store the captured image of the business card, which is to be read out to be transmitted from appliance communication apparatus 16 to phone communication apparatus 24.

Cellular phone 4 is capable of communicate with personal identification server 6 by means of phone function unit 36 through Internet 41. On the other hand, identification server 6, which includes server controller 42, voice print database 44, face database 46, OCR database 48 and input/output interface 50, communicates with a great number of other cellular phones and a great number of other assist appliances of cognitive faculty. Identification server 6, thus, collects and accumulates voice print data, face data and OCR data of the same person gotten on various opportunities of communicating with various cellular phones and various assist appliances. The voice print data, face data and OCR data are collected and accumulated under high privacy protection. And, the accumulated voice print data, face data and OCR data are shared by the users of identification server 6 under high privacy protection for the purpose of improving accuracy of reference data for personal identification. The data structure of the voice print data, face data and OCR data as reference data stored in cognitive assisting data storage 32, on the other hand, are identical with those of reference data in voice print database 44, face database 46, OCR database 48 of identification server 6. However, among all the reference data in voice print database 44, face database 46, OCR database 48 of identification server 6 gotten by and uploaded from other cellular phones and other assist appliances, only reference data of a person who has given a self-introduction to the user of cellular phone 4 are permitted to be downloaded from identification server 6 to cognitive assisting data storage 32 of cellular phone 4. In other words, if reference data of a conversation partner gotten by assist appliance 2 is uploaded from assisting data storage 32 of cellular phone 4 to identification server 6, the uploaded reference data will be permitted by the identification server 6 to be downloaded by another cellular phone of a second user on the condition that the same conversation partner has given a self-introduction also to the second user. Identification server 6 will be described later in more detail.

Assisting APP 30 and cognitive assisting data storage 32 of cellular phone 4 function not only in combination with appliance camera 12 and appliance microphone 14 of assist appliance 2, but also in combination with phone camera 37 and phone function unit 36 of cellular phone 4. In other words, phone function unit 36 receives voice of intended party during phone conversation, the received voice including voice print information of the intended party. Thus, assisting APP 30 and cognitive assisting data storage 32 carries out the personal identification on the basis of voice print information in the voice received by phone function unit 36 for assisting cognitive faculty of the user. Further, phone camera 37 captures own face of the user on an opportunity such as video phone conversation, the face data of the captured face of the user being provided to identification server 6 as reference data for other persons to identify the user.

Next, the way of getting reference data for personal identification will be explained. As to face data, appliance camera 12 captures the face of a conversation partner on an opportunity of the first meeting when the front side of the head of the user is oriented toward the conversation partner. Image data of the captured face as well as face features extracted from the image data are stored in cognitive assisting data storage 32 by way of appliance memory 10, appliance communication apparatus 16, and phone communication apparatus 24. On the same opportunity of the first meeting with the conversation partner, appliance microphone 14 gets voice of the conversation partner. Voice data of the gotten voice as well as voice print extracted from the voice data are stored in cognitive assisting data storage 32 by way of appliance memory 10, appliance communication apparatus 16, and phone communication apparatus 24.

To determine whose face features and whose voice print had gotten according to the above mentioned manner, the voice of self-introduction from the first met conversation partner is firstly utilized. Further, if a business card is handed to the user from the first met conversation partner, the character information on the business card is utilized. In the case of utilizing voice, assisting APP 30 extracts the self-introduction part as the linguistic information supposedly existing in the voice data corresponding to the opening of conversation stored in cognitive assisting data storage 32, and narrows down the extraction to the name part of the conversation partner as the linguistic information. Thus extracted name part recognized as the linguistic information is related to the face features and the voice print to be stored in cognitive assisting data storage 32. In other words, the voice data is utilized as a dual-use information, e.g., the reference voice print data for personal identification and the name data as the linguistic information related to each other. Not only a case that appliance microphone 14 of assist appliance 2 is utilized to get voice of the conversation partner in front of the user as explained above, but also such a case is possible that the voice of the intended party far away received through function unit 36 during phone conversation is utilized.

Further, if a business card is handed to the user from the first met conversation partner, appliance camera 12 captures the image of the business card when the head of the user faces the business card as explained above. And, OCR 39 of cellular phone 4 reads a name from an image of a business card to convert the captured name into text data. Thus converted text data as linguistic information is related to the face features and the voice print to be stored in cognitive assisting data storage 32. The conversion of the image of business card into the text data by OCR 39 as explained above is useful in such a case that a self-introduction is made only by showing a business card with redundant reading thereof omitted.

On the other hand, if a self-introduction is made by showing a business card with announcement of the name accompanied, both the name data on linguistic information of the voice and the name data on text data from the business card read by OCR 39 of cellular phone 4 are cross-checked with each other. And, if one of the name data contradict the other, one of the name data of higher probability is adopted as the final name data by means of a presumption algorithm of assisting APP 30. In detail, text data from the business card is to be preferred unless the business card is blurred and illegible.

Next, the function in the case of meeting again is to be explained. Occasionally, a conversation partner may not give her/his name in the case of meeting again. In such a case, the user may hardly remind the name of the meeting again conversation partner. And, if such a memory loss is repeatedly experienced, the user may have a lapse of confidence, which may cause a social withdrawal. Similarly in the case of phone conversation, if the user may hardly remind the name of intended party in spite of clearly recognizing her/his voice and face and such experience may be repeatedly experienced, the user may avoid receiving a call in the first place. For assisting demented persons or elderly person to keep sound sociability, appliance microphone 14 of assist appliance 2 gets voice of the meeting again conversation partner to transmit the gotten voice data to phone controller 26 by means of communication between appliance communication apparatus 16 and phone communication apparatus 24. The voice print data in the transmitted voice data is compared with reverence voice print data stored in cognitive assisting data storage 32 by means of the function of phone controller 26 running on the processing program in assisting APP 30. And, if the transmitted voice print data coincides with one of reverence voice print data, name data related to the coincided reference voice print data is transmitted from phone communication apparatus 24 to appliance communication apparatus 16. The transmitted name data is displayed by visual field display 18 and audibly outputted from one of the pair of channels of stereo earphone 20.

Similar assistance in the case of meeting again is made also with respect to face data. Appliance camera 12 of assist appliance 2 captures the face of a conversation partner on an opportunity of the meeting again when the front side of the head of the user is oriented toward the meeting again conversation partner. The captured image data of the face is transmitted to phone controller 26 by means of communication between appliance communication apparatus 16 and phone communication apparatus 24. And, as has been explained, the face features in the transmitted face image is compared with reverence face features stored in cognitive assisting data storage 32 by means of the function of phone controller 26 running on the processing program in assisting APP 30. And, if the face features of the transmitted face image coincides with one of reverence face features, name data related to the coincided reference face features is transmitted from phone communication apparatus 24 to appliance communication apparatus 16. The transmitted name data is displayed by visual field display 18 and audibly outputted from one of the pair of channels of stereo earphone 20. Further, as has been explained, the personal identification on the basis of voice print data and the personal identification on the basis of face features are cross-checked whether or not both the results identify the same person. If not, one of the results of higher probability is adopted as the final personal identification by means of a presumption algorithm in cognitive faculty assisting application program stored in application storage 30.

In visually displaying the transmitted name by means of visual field display 18 for assisting cognitive faculty in the above explained manner, the name is recommended to be displayed at lower part of the visual field close to the margin thereof so as not to interrupt the visual field although the displayed name may identifiably overlap the real visual field without intermingling therewith since the name is displayed in the real visual field viewed through the pair of eyeglass lenses 22. On the contrary, in audibly informing of the transmitted name by means of stereo earphone 20, the audibly informed name may overlap the real voice from the conversation partner to intermingle therewith, which may result in that both the audibly informed name and the real voice from the conversation partner are hard to hear. To avoid such a situation, the name is audibly outputted only from one of the pair of channels of stereo earphone 20, which makes it easy to differentiate the audibly informed name from the real voice from the conversation partner coming into both the pair of ears of the user. Alternatively, in the case that assist appliance also functions as a hearing aid, the name is audibly outputted from one of the pair of channels of stereo earphone 20 and the amplified voice of the conversation partner is audibly outputted from the other of the pair of channels of stereo earphone 20. Further, in place of audibly outputting the name from one of the pair of channels of stereo earphone 20, the name can be started to audibly output from both the pair of channels of stereo earphone 20 during a blank period of conversation by detecting a beginning of pause of voice from the conversation partner. Or, both the output of audibly informed name from only one of the pair of channels of stereo earphone 20 and the output of audibly informed name during a blank period of conversation by detecting a beginning of pause of voice from the conversation partner can be adopted in parallel for the purpose differentiating the audibly informed name from the voice from the conversation partner.

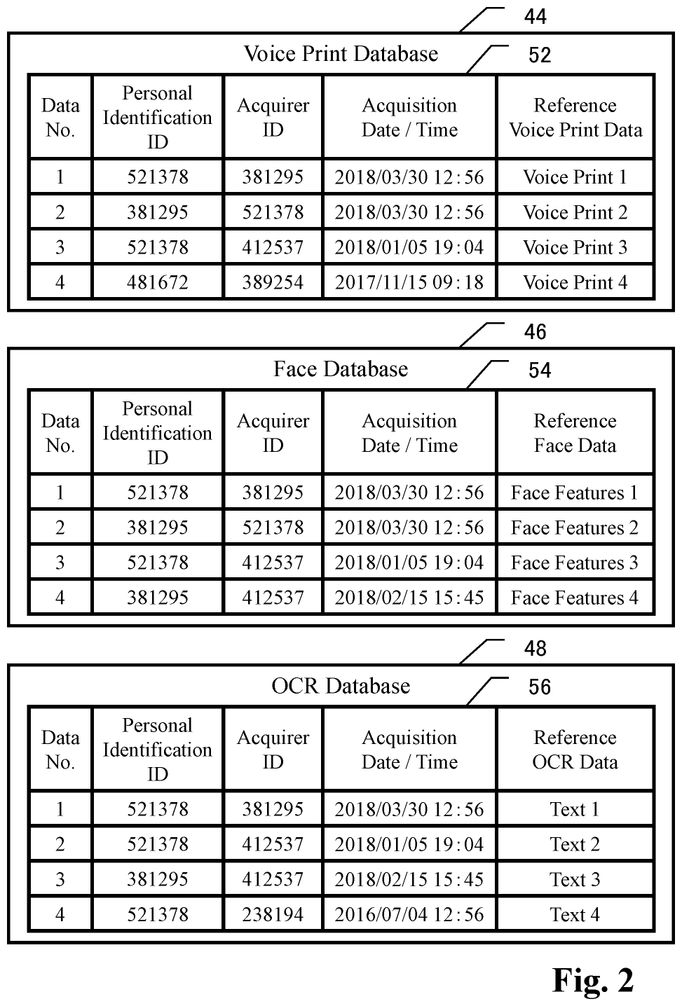

FIG. 2 represents a table showing data structure and data sample of reference voice print data 52, reference face data 54 and reference OCR data 56 which are stored in voice print database 44, face database 46 and OCR database 48 of identification server 6, respectively. Server controller 42 shown in FIG. 1 carries out data control according to the data of the above mentioned data structure in cooperation with a great number of cellular phones, the details of the data control being explained later. The respective data structure of reference data shown in FIG. 2 consists, in the case of reference voice print data 52 for example, “data No.”, “personal identification ID”, “acquirer ID”, “acquisition date/time”, and “reference voice print data”. For example, the “data No. 1” corresponds to “voice print 1” for identifying a parson to whom “521378” is assigned as “personal identification ID”. Although the real name of the person corresponding to “personal identification ID” is registered in identification server 6, such a real name is not open to the public. Further, “521378” as “personal identification ID” in reference voice print data 52 is assigned to a person whose name is recognized as the linguistic information extracted from a voice of self-introduction also used to extract “voice print 1”. Thus, concern about false recognition of the pronounced name still remains in “data No. 1” by itself.

Further, reference voice print data 52 in voice print database 44 shows that “data No. 1” is acquired at “12:56” on “Mar. 30, 2018” as “acquisition date/time” by a person assigned with “3812952” as “acquirer ID”, and uploaded by him/her to identification server 6, for example. Thus, if a voice print actually gotten from a conversation partner in front of the user is compared with and coincides with “voice print 1” of “data No. 1” in voice print database 44, the conversation partner in front of the user is successfully identified as a person to whom “521378” is assigned as “personal identification ID”.

The data of reference voice print data 52 is allowed to be downloaded from identification server 6 into cognitive assisting data storage 32 of cellular phone 4 held by a user as own reference data on condition that the reference voice print data is of a person who has made a self-introduction to the user even if the reverence voice print data has been acquired by others. In other words, cognitive assisting data storage 32 stores number of reference voice print data which are not only acquired by own assist appliance 2 and own cellular phone 4, but also are downloaded from identification server 6 on condition explained above. Such reference voice print data in cognitive assisting data storage 32 will be thus updated day by day.

In detail, “data No. 3” in reference voice print data 52 is acquired by another person assigned with “412537” as “acquirer ID”, who has been given a self-introduction by the person assigned with “521378” as “acquirer ID”, and independently uploaded by him/her to identification server 6, for example. In other words, the person assigned with “521378” as “acquirer ID” has given a self-introduction both to the person assigned with “381295” as “acquirer ID” according to “data No. 1” and to the person assigned with “412537” as “acquirer ID” according to “data No. 3”. This means that the person assigned with “521378” as “acquirer ID” has not any objection to such a situation that her/his name related with her/his voice print data is disclosed to both the person assigned with “381295” as “acquirer ID” and to the person assigned with “412537” as “acquirer ID” among whom “voice print 1” and “voice print 3” are shared. Accordingly, “data No. 1” and “data No. 3” are downloaded for sharing thereof both to the cognitive assisting data storage of the assist appliance owned by the person assigned with “381295” as “acquirer ID” and to the cognitive assisting data storage of the assist appliance owned by the person assigned with “412537” as “acquirer ID”. Thus, reference voice print data of the same person gotten by specific different persons taking different opportunities are shared by specific different persons on the condition that the same person has given a self-introduction both to the specific different persons. The shared reference voice pint data are cross-checked upon the personal identification to increase accuracy and efficiency of the personal identification on the voice print. However, since the data sharing is carried out on the identification (ID) without disclosing to the public the real name of the person assigned with the ID as described above, such privacy that a first person who is acquainted with a second person is also acquainted with a third person is prevented from leaking through the data sharing.

The data structure of reference face data 54 is identical with that of reference voice print data 52 except that the contents of reference face data 54 is “face features 1” etc. whereas the contents of reference voice print data 52 is “voice print 1” etc. Further, “personal identification ID” in reference voice print data 54 is assigned to a person whose name is recognized as the linguistic information extracted from a voice of self-introduction as in the case of the reference voice print data 52. Thus, concern about false recognition of the pronounced name still remains in “personal identification ID” of the reference face data 54 by itself.

With respect to the data sample in FIG. 2 relating to reference voice print data 52 and reference face data 54, “personal identification ID” and “acquirer ID” in “data No. 1” switch positions with those in “data No. 2” in both reference voice print data 52 and reference face data 54, in contrast to that “acquisition date/time” is the same in all of “data No. 1” and “data No. 2” of reference voice print data 52 and reference face data 54. This means that all the above mentioned data have been uploaded to personal identification server 6 based on the same opportunity of the meeting between the person assigned with “521378” as “personal identification ID” and the person assigned with “381295” as “personal identification ID”. Further, the data sample in FIG. 2 above show that all of the face features, the voice print and the name as the linguistic information extracted from the voice are successfully gotten from both the persons on the same opportunity.

With respect to the data sample in FIG. 2, on the other hand, no reference face features data corresponding to “voice print 4” of voice print data 52 is uploaded into reference face data 54. The reason is presumed that “voice print 4” has been gotten through phone conversation without face features information. Similarly, no reference voice print data corresponding to “face features 4” of reference face data 54 is uploaded into voice print data 52. The reason in this case is presumed that “face features 4” has been gotten through a meeting with a deaf person without voice or the like. In the case of such a “face features 4”, “personal identification ID” related thereto in “data No. 4” is presumed to be determined by means of a cross-check with data in reference OCR data 56 (gotten not only by reading a business card, but also by reading a message exchanged in writing conversation) explained later. Or, “personal identification ID” in “data No. 4” of reference face data 54 is presumed to be manually inputted by means of manual operation part 38 of cellular phone 4.

The data structure of reference OCR data 56 is identical with that of reference voice print data 52 and reference face data 54 except that the contents of reference OCR data 56 is “text 1” etc. whereas the contents of reference voice print data 52, for example, is “voice print 1” etc. Such a difference should be noted, however, that “personal identification ID” in reference OCR data 56 is of a higher reliability than those in reference voice print data 52 and reference face data 54 in that “personal identification ID” in reference OCR data 56 is based on direct reading of name, except for a rare case of miss-reading caused by a blurred character or an illegible character. By the way, reference OCR data 56 does not include any data corresponding to “data No. 2” in reference voice print data 52 and reference face data 54 in contrast to that reference OCR data 56 includes “data No. 1” corresponding to “data No. 1” in reference voice print data 52 and reference face data 54 which have been gotten in the same opportunity. This suggests that no business card has been provided from the person assigned with “381295” as “personal identification ID” to the person assigned with “521378” as “personal identification ID”. On the other hand, according to “data No. 3” uploaded into reference OCR data 56, the person assigned with “381295” as “personal identification ID” is assumed to provide a business card to another person assigned with “412537” as “personal identification ID”. And it is clear from reference voice print data 52 and reference face data 54 as discussed above that the person assigned with “381295” as “personal identification ID” has already given a self-introduction to the person assigned with “521378” as “personal identification ID”. This means that the person assigned with “381295” as “acquirer ID” has not any objection to such a situation that “data No. 3” including her/his real name is disclosed to the person assigned with “521378” as “personal identification ID”. Accordingly, “data No. 3” reference OCR data 56 is downloaded to the cognitive assisting data storage of the assist appliance owned by the person assigned with “521378” as “acquirer ID”. Thus, the reference OCR data of a specific person gotten by limited different persons taking different opportunities is shared by the limiter different persons on the condition that the specific person has given a self-introduction to the limited different persons. The OCR data is sheared and cross-checked with another shared reference OCR data if any upon the personal identification to increase accuracy and efficiency in cognitive faculty assistance.

The functions and the advantages of the present invention explained above are not limited to the embodiments described above, but are widely applicable to other various embodiments. In other words, the embodiment according to the present invention shows the system including assist appliance 2 of cognitive faculty incorporated in spectacles with hearing aid, cellular phone 4, and personal identification server 6. However, the assist appliance of cognitive faculty can be embodied as other appliance which is not incorporated in spectacles with hearing aid. Further, all the functions and the advantages of the present invention can be embodied by a cellular with the assist appliance omitted. In this case, the image of a business card necessary for optical character reader 39 is captured by phone camera 37 within cellular phone 4. And, the cognitive faculty assisting application program such as assisting APP 30 according to the present invention is prepared as one of various cellular phone APP's to be selectively downloaded from a server.

The above explanation is given on the term, “OCR data” with “OCR database 48” and “reference OCR data 56” represented in FIGS. 1 and 2. In substance, however, these terms mean “name data”, “name database 48” and “reference name data 56”, respectively, which are informed by text data capable of being recognized as linguistic information. As explained above, such name data as text data can be obtained, in detail, by optical recognition of linguistic information based on reading the character of the business card by OCR, or by phonetic recognition of linguistic information based on the voice data picked-up through the microphone. And, further explained above, if a business card is provided with announcement of the name accompanied, both the text data on the OCR of business card and the text data on the phonetic recognition are cross-checked to prefer the former to the latter unless the business card is blurred and illegible. This is the reason why the above explanation is given on the specific term, “OCR data” with “OCR database 48” and “reference OCR data 56” represented in FIGS. 1 and 2 as a typical case. In other words, the terms shall be replaced with “name data”, “name database 48” and “reference name data 56”, respectively, in the broad sense.

Or, the terms shall be replaced with “phonetic recognition data”, “phonetic recognition database 48” and “reference phonetic recognition data 56”, respectively, in such a case that the name data is to be obtained by phonetic recognition of linguistic information based on the voice data.

In the above described embodiment, on the other hand, the reference data in voice print database 44, face database 46 and OCR database 48 are encrypted, respectively. And, decryption of the reference data is only limited to a cellular phone 4 with a history of uploading reference data of voice print database 44 or of face database 46 of a person in connection with reference data of OCR database 48 of the same person. Accordingly, any third party without knowing about face-name pair or voice-name pair of a person is inhibited from searching for face data or voice data on OCR data of the person, or in reverse, searching for OCR data on face data or voice data of the person.

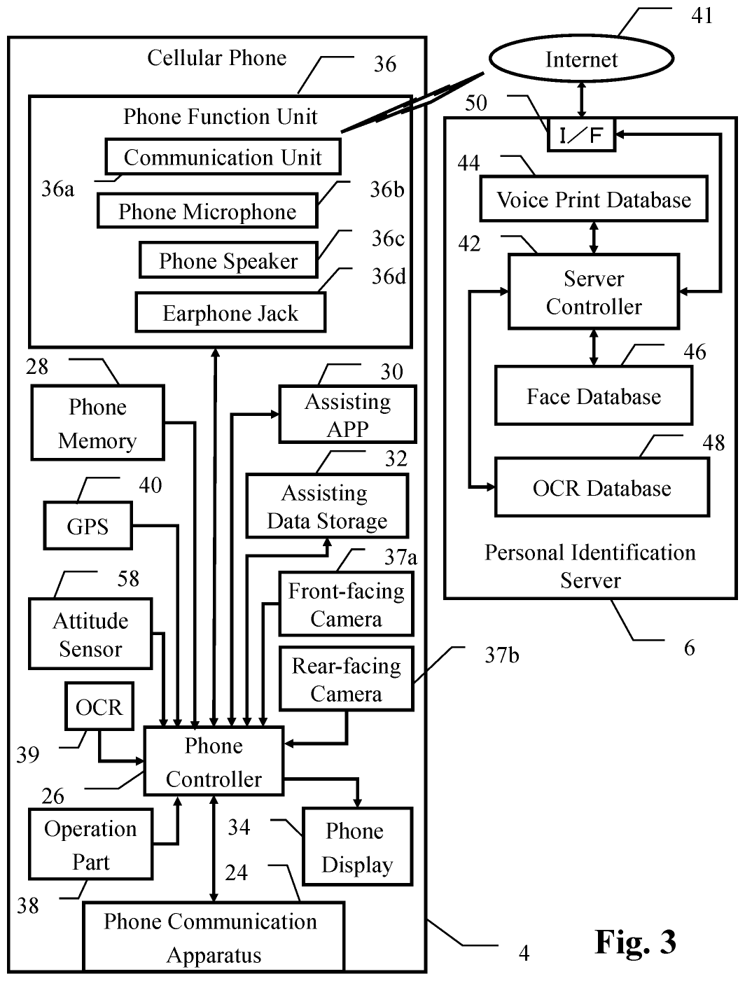

FIG. 3 represents a block diagram of the embodiment of the present invention, in which the structure in cellular phone 4 is shown in more detail for the purpose of explaining a case that assist appliance 2 is omitted, for example, from the total system shown in FIG. 1. In other words, FIG. 3 shows front-facing camera 37a and rear-facing camera 37b in separation, which correspond to phone camera 37 shown in FIG. 1 in collective meaning. Further in FIG. 3 shows sub-blocks 36a to 36d within phone function unit 36 collectively shown in FIG. 1. In the case that assist appliance 2 is omitted, rear-facing camera 37b of cellular phone 4 is so arranged to capture the image of the name on the business card for OCR 39 to read the name. Further, in phone function unit 36 shown in FIG. 1, communication unit 36a in FIG. 3 works for communication with personal identification server 6 via internet 41. Still further, video phone is possible by means of combination of front-facing camera 37a and phone microphone 36b in phone function unit 36 in FIG. 3

As has been described, the combination of front-facing camera 37a and phone microphone 36b in phone function unit 36 is utilized for the above mentioned cognitive assisting faculty. For example, face data of the user of cellular phone 4 captured by front-facing camera 37a is transmitted to personal identification server 6 as reference data for the cognitive assisting faculty. On the other hand, voice print data of the user of cellular phone 4 gotten by phone microphone 36b is transmitted to personal identification server 6 as reference data for the cognitive assisting faculty. These reference data are utilized by other persons than the user of cellular phone 4 when accessing personal identification server 6 for the cognitive assisting faculty. In other words, reference data above is utilized by other persons to recognize the user of cellular phone 4.

In the case of cognitive assisting faculty for the user of cellular phone 4 to recognize the conversation partner, on the other hand, the face image including face data of the conversation partner is captured by rear-facing camera 37b, and the voice including voice print data of the conversation partner is gotten by phone microphone 36b. On the basis of the face data and the voice print data, the name or the like of identified conversation partner is visually indicated on phone display 34. As explained above, this function of cellular phone 4 is useful especially in such a case that assist appliance 2 is omitted in the system. Further, in the case of omission of assist appliance 2, the name or the like of identified conversation partner is phonetically outputted from phone speaker 36c with a volume sufficient for the user to hear but sufficiently low so that the conversation partner can hardly hear. Alternatively, the phonetic output is possible through an earphone connected to earphone jack 36d for the user to hear the name or the like of the identified conversation partner.

In some case, it may be impolite to take out or to operate cellular phone during conversation for the purpose of knowing the name of the conversation partner with the aid of the visual or phonetic output. To avoid this case, the data identifying the conversation partner may be temporarily recorded for the user to playback the visual display or the phonetic output later in place of real time output. Or, if the user scrambles names and faces on the eve of a meeting with an acquaintance, it may be possible to search a name of the acquaintance from her/his face image or vice versa for confirming the name and face of the acquaintance in advance to the meeting if identification data of the acquaintance has been recorded on the occasion of the former meeting. Further, it may be possible to accumulate personal identification data of the same person every time with each meeting date/time data and each meeting place data based on GPS 40, which may form a useful history of meeting with the same person.

For attaining the above function, reference data of a conversation partner is absolutely necessary. However, it may cause a privacy issue to take such an action as to take a photograph or to record voice of a person just met for the first time for the purpose of getting the reference data. Thus, it is just to be polite to obtain consent of the person in advance to such an action as a matter of human behavior. In addition, assisting APP 30 includes an automatic function to assist the user in obtaining the consent of the person in advance. In detail, assisting APP 30 is configured to automatically make a begging announcement in advance, such as “Could you please let me take a photograph of your face and record your voice for attaching to data of your business card in case of my impoliteness on seeing you again.” This is accomplished, for example, by automatically sensing both the taking-out of cellular phone 4 by means of attitude sensor 58 (corresponding to geomagnetic sensor and acceleration sensor originally existing in the cellular phone for automatically switching phone display 34 between vertically long display and horizontally long display) and conversation voice expected in a meeting by means of turning-on phone microphone 36b in response to the sensing of the taking-out of cellular phone 4. And, the above mentioned begging announcement is started to be outputted from phone speaker 36c when it is decided based on the above sensing that cellular phone 4 is taken-out during the meeting. Thereafter, a response of the conversation partner to the begging announcement is waited for a predetermined time period. And if the response is refusal, a manual operation is made within the predetermined time period to input an instruction not to take a photograph of the face and record the voice but to attach data of the refusal to the data of received business card. On the contrary, if no manual operation is made within the predetermined time period, start of the photograph of the face and the record the voice are allowed to be carried out.

The functions and the advantages of the present invention explained above are not limited to the embodiments described above, but are widely applicable to other various embodiments. In the embodiment according to the present invention, for example, the upload and download of the reference data constitute the cooperation between cellular phone 4 and personal identification server 6 with respect to the identification of a person, whereas the function itself for identifying the person is carried out by cellular phone 4. In detail, the personal identification is carried out by assisting APP 30 within cellular phone 4 by means of comparing the data obtained by assist appliance 2 or cellular phone 4 on the occasion of meeting a person again with the reference data stored in assisting data storage 32, the reference data having been downloaded from personal identification server 6 in some cases. However, this function of personal identification is not limited to be carried out according to the above mentioned manner in the embodiment, but can be carried out according to another type of embodiment.

For example, the above mentioned function of the personal identification carried out by assisting APP 30 of cellular phone 4 may alternatively be so modified as to be carried out by personal identification server 6. In detail, the data obtained by assist appliance 2 or cellular phone 4 on the occasion of meeting a person again is to be sent from pone function unit 36 to input/output interface 50 of personal identification server 6. And personal identification server 6 is to compare the received data with the reference data stored in voice print database 44, face database 46, OCR database 48 to send data of personal identification as the result of the comparison back to cellular phone 4. In this modification, personal identification server 6 is to send the data of personal identification, which correlates the data in voice print database 44 and in face database 46 with the data in OCR database 48, only to cellular phone 4 which has actually sent the data obtained on the occasion of meeting the person again, which is essential to privacy of the involved parties.

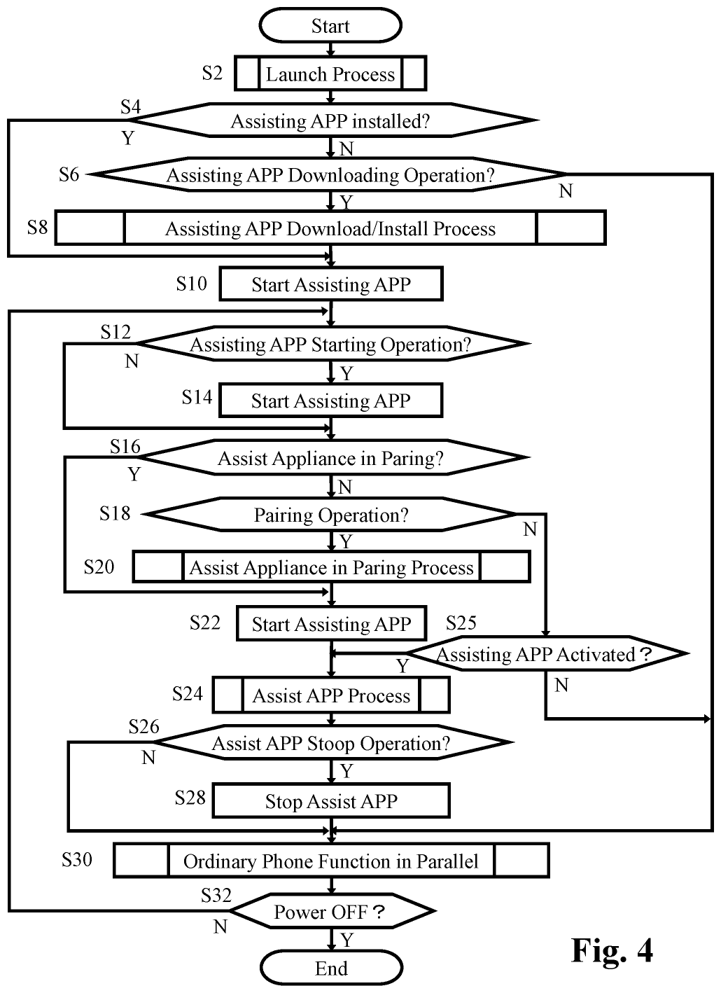

FIG. 4 represents a basic flowchart showing the function of phone controller 26 of cellular phone 4 according to the embodiment shown in FIGS. 1 to 3. The flow starts in response to turning-on of cellular phone 4 and launches cellular phone 4 in step S2. Further in step S4, it is checked whether assisting APP has been installed or not. Assisting APP 30 is capable of being downloaded into cellular phone 4 as one of various cellular phone APP's for a smartphone.

If it is determined in step S4 that assisting APP 30 has not been installed, the flow goes to step S6, in which it is checked whether or not an operation necessary for downloading assisting APP is done. This check in step S6 includes a function to wait for manual operation part 38 to be suitably operated within a predetermined time period. If it is determined in step S6 that the operation is done within the predetermined time period, the flow goes to step S8 to download the assisting APP from personal identification server 6 to install the same on cellular phone 4. When the installation of assisting APP has been completed, the flow goes to step S10 to start the installed assisting APP automatically. On the other hand, if it is determined in step S4 that the assisting APP has been already installed, the flow jumps to step S10 directly to automatically start the assisting APP.

Next, it is checked in step S12 whether or not operation part 38 is operated to start the assisting APP. If the operation is determined in step S12, the flow goes to step S14 to start the assisting APP, and step S16 follows. On the contrary, the flow jumps to step S16 directly if it is determined in step S12 that operation part 38 is not operated to start the assisting APP. It should be noted, in the case that the flow goes to step S12 via step S10, nothing substantially occurs in steps S12 and S14 since the assisting APP has already been started through step S10. On the contrary, there may be a case that the flow comes to step S12 with the assisting APP having been stopped by operation part 38 during operation of cellular phone as will be explained later. In such a case, if it is determined in step S12 that operation part 38 is not operated to start the assisting APP, the flow goes to step S16 with the assisting APP continued to be stopped.

In step S16, it is checked whether or not the pairing condition between cellular phone 4 and assist appliance 2 is established. If the pairing with assist appliance 2 has been set at cellular phone 4 in advance, the pairing between cellular phone 4 and assist appliance 2 will be established concurrently with the launch of cellular phone 4 in response to turning-on thereof, whereby the cooperation between cellular phone 4 and assist appliance 2 will instantly start. If the pairing condition is not determined in step S16, the flow goes to step S18 to check whether or not a manual operation is done at operation part 38 for setting the pairing between cellular phone 4 and assist appliance 2. It should be noted that step S18 also includes a function to wait for the manual operation part 38 to be suitably operated within a predetermined time period. If it is determined in step S18 that the operation is done within the predetermined time period, the flow goes to step S20 to carry out a function to establish the pairing condition between cellular phone 4 and assist appliance 2. Since the above mentioned function is carried out in parallel with the succeeding functions, the flow advances to step S22 prior to the completion of establishing the pairing condition. On the other hand, if the pairing condition is determined in step S16, the flow goes directly to step S22.

In step S22, the assisting APP is activated to go to step S24. It should be noted that substantially nothing will occur in step S22 if the flow comes to step S22 by way of step S10 or step S14, wherein the assisting APP has already been activated at step S22. To the contrary, if the flow comes to step S16 with the assisting APP deactivated, step S22 functions to activate the assisting APP. On the other hand, if it is not determined in step S18 that the operation is done within the predetermined time period, the flow goes to step S25 to check whether or not the assisting APP has been activated through step S10 or step S14. And if it is determined in step S25 that the assisting APP has been activated, the flow advances to step S24.

In summary, the assisting APP is activated when the assisting APP is download and installed (step S8), or when operation part 38 is operated to start the assisting APP (step S12), or when the determination is done with respect to the pairing condition (step S16 or step S18). And, by the activation of the assisting APP which leads to step S24, the function of the assisting APP is carried out. Since the function of step S24 for the function of the assisting APP is carried out in parallel with succeeding functions, the flow advances to step S26 prior to the completion of the function of the assisting APP in step S24.

In step S26, it is checked whether or not an operation to stop the function of assisting APP is done at operation part 38. If the operation is determined, the flow goes to step S28 to stop the function of assisting APP, and then goes to step S30. On the contrary, if it is not determined in step S26 that the operation to stop the assisting APP is done, the flow goes to step S30 directly. By the way, if it is not determined in step S6 that the operation to download assisting APP is done, or it is not determined in step S25 that the operation to start the assisting APP is done, the flow also goes to step S30 directly.

In step S30, ordinary operation relating to cellular phone is carried out. Since this operation is carried out in parallel with the operation of the assisting APP, the flow goes to step S32 prior to the completion of the ordinary operation of cellular phone. In step S32, it is checked whether or not cellular phone 4 is turned off. If it is not determined that cellular phone 4 is turned off, the flow goes back to step S12. Accordingly, the loop from step S10 to step S32 is repeated unless it is determined that cellular phone 4 is turned off in step S32. And, through the repetition of the loop, various operations relating to the start and the stop of the assisting APP and to the pairing between cellular phone 4 and assist appliance 2 are executed as well as carrying out the ordinary phone function in parallel with the function of the assisting APP in operation. On the other hand, if it is detected in step S32 that cellular phone 4 is turned off, the flow is to be terminated.

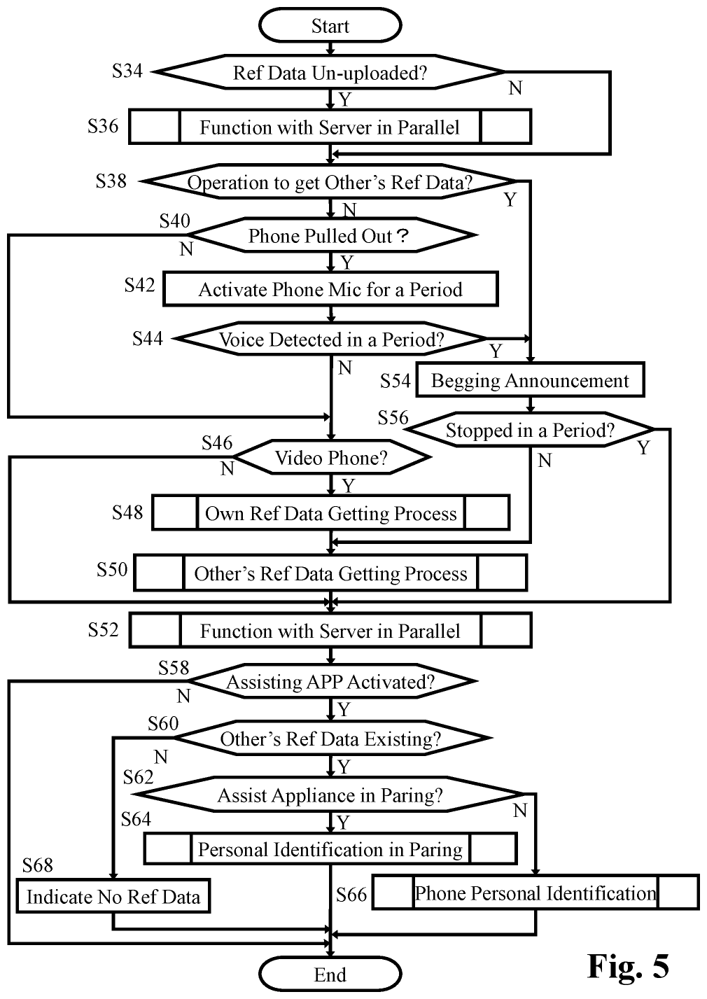

FIG. 5 represents a flowchart showing the details of the parallel function of the assisting APP in step S24 in FIG. 4. At the beginning of the parallel function of assisting APP, it is checked in step S34 whether or not any reference data gotten by cellular phone 4 has not been uploaded into personal identification server 6. If any, the flow advances to step S36, in which a parallel function in cooperation with personal identification server 6 is carried out. The parallel function in S36 cooperative with personal identification server 6 includes the upload of the reference data into personal identification server 6, the download of the reference data from personal identification server 6, and the search for the reference data based on the gotten data, the details of which will be explained later in detail. In any way, if the flow comes to step S36 by way of step S34, un-uploaded reference data is uploaded into personal identification server 6 in step S36. Since step S36 is carried out in parallel with the succeeding functions, the flow advances to step 38 prior to the completion of the uploading function. On the other hand, if it is determined in step S34 that no reference data is left un-uploaded, the flow directly goes to step S38.

In step S38, it is checked whether or not an operation is done at manual operation part 38 to get reference data form a conversation partner on an opportunity of the first meeting. This operation will be made in such a case that the user already holding cellular phone 4 in her/his hand feels a necessity of getting reference data form the conversation partner and instantly sets a position to make the manual operation. The case of the manual operation determined in step S38 will be explained later. On the other hand, if the manual operation is not determined in step S38, the flow is advanced to step S40.

In step S40, it is checked whether or not attitude sensor 58 senses an action of the user to pull out cellular phone 4 from a pocket of her/his coat or the like. If the action is sensed, the flow advances to step S42 to automatically activate phone microphone 36b of cellular phone 4 for a predetermine time period, whereby preparation is done for picking up voice of a conversation partner on an opportunity of the first meeting. In this case, if cellular phone 4 is in cooperation with assist appliance 2 by means of the establishment of the pairing condition, appliance microphone 14 functioning as a part of the hearing aid is also utilized in step 42 for picking up voice of the conversation partner for the purpose of getting voice print. Then, the flow advanced to step S44 to check whether or not voice of the meeting conversation is detected within a predetermined period of time. The above function is for automatically preparing to pick up voice of a conversation partner by means of utilizing the action of the user to pull out cellular phone 4 when she/he feels a necessity of getting reference data form the conversation partner. The case of detection of the voice within the predetermined period of time in step S44 will be explained later. On the other hand, if the voice is not detected in the predetermined period of time in step S44, the flow is advanced to step S46. The flow also advanced to step S46 directly from step S40 if the action of the user to pull out cellular phone 4 is not detected.

As in the above explanation, steps S40 to S44 corresponds to the function for automatically preparing to pick up voice of a conversation partner by means of utilizing the action of pulling out cellular phone 4 by the user who feels a necessity of getting reference data form the conversation partner and in response to the succeeding detection of the voice within the predetermined period of time. The case of detection of the voice within the predetermined period of time in step S44 will be explained later.

In step S46, it is checked whether or not a video phone conversation is started. The video phone conversation is a good opportunity of getting reference data of the conversation partner for personal identification since face image and voice of the conversation partner are received through communication unit 36a of cellular phone 4. The video phone conversation is also a good opportunity of getting own reference data of the user since the user face image is taken by front-facing camera 37a and the user voice is picked up by phone microphone 36b. If the start of the video phone conversation is detected in step S46, the flow goes to step S48 to carry out the process of getting own reference data. And, the process of getting reference data of the conversation partner is carried out in step S50. Since steps S48 and S50 are carried out in parallel, the flow advances to step 50 prior to the completion of the process in step S48. And, in response to the completion of both steps S48 and S50, the flow goes to step S52 to carry out the parallel function in cooperation with personal identification server 6.

With respect to steps S46 to S50 above, the opportunity of video phone with both voice and face image gotten is explained. However, at least reference date of voice print can be gotten even by ordinary phone function in which only voice is exchanged. Therefore, the above explained flow should be understood by substituting “phone” for “video phone” in step S46 and omitting functions relating to face image if the above function is applied to the ordinary voice phone. Similar substitution and omission is possible with respect to the following explanation.

The parallel function in cooperation with personal identification server 6 in step S52 is similar to that in step S36, the details of which will be explained later. In short, the reference data is uploaded to personal identification server 6 in step S52 as in step S36. Specifically in step S52, the reference data newly gotten through step S48 and/or step S50 are uploaded to personal identification server 6.

If the start of the video phone conversation is not detected in step S46, the flow directly goes to step S52. In this case, although there is no newly gotten reference data, the process for downloading reference data from personal identification server 6 and the process for searching the reference data based on the gotten reference data are carried out according to the parallel function in cooperation with personal identification server 6 in step S52, the details of which will be explained later.

On the other hand, if it is detected in step 38 that the operation is done at manual operation part 38 to get reference data form a conversation partner, or if it is determined in step S44 that the voice of the meeting conversation is detected within the predetermined period of time, the flow goes to step S54. In step S54, prior to taking a photo of the face of the conversation partner and recording voice of the conversation partner, such a begging announcement is automatically made that “Could you please let me take a photograph of your face and record your voice for attaching to data of your business card in case of my impoliteness on seeing you again.” And, in parallel with the start of the begging announce, the flow is advanced to step S56 to check whether or not a manual operation is done within a predetermined time period after the start of the begging announce to refrain from taking the photo of the face and recording the voice. This will be done according to the will of conversation partner showing refusal of taking the photo and recording the voice.

If the refraining manual operation within the predetermined time period is determined in step S56 after the start of the begging announce, the flow goes to step S52. Also in this case of transition to step S52 by way of step S56, although there is no newly gotten reference data, the process for downloading reference data from personal identification server 6 and the process for searching the reference data based on the gotten reference data are carried out according to the parallel function in cooperation with personal identification server 6 in step S52, which is similar to the case of transition to step S52 by way of step S46. Since step S52 is carried out in parallel with the succeeding functions, the flow advances to step 58 prior to the completion of the process in step S52.

In step S58, it is checked whether or not an operation is done at operation part 38 to activate the assisting APP. This operation is typically done by the user of cellular phone 4 without being sensed by a conversation partner in such a case that the user has forgotten the name of the conversation partner whereas the conversation partner would not present a business card nor make any self-introduction because of meeting again. In other words, the user makes the operation behind the curtain to get face data and/or voice print data for personal identification of the conversation partner meeting again. If the operation for activating the assisting APP is determined in step S58, the flow goes to step S60 to check whether or not any reference data exists. If any reference data of a conversation partner is determined in step S60, the flow goes to step S62. It should be noted that the determination in step S60 that “reference data exists” means not only the case that the reference data of the conversation partner is stored in assisting data storage 32 of cellular phone 4. But, the determination in step S60 that “reference data exists” also means the case that the reference data of the conversation partner can be searched by means of the parallel function in S36 cooperative with personal identification server 6 even if no reliable reference data of the conversation partner is stored in assisting data storage 32 of cellular phone 4, which results in the transition from step S60 to step S62.

In step S62, it is checked whether or not the pairing condition between cellular phone 4 and assist appliance 2 is established. If the pairing condition is determined, the flow is advanced to step S64 for carrying out personal identification under the paring condition, and then the flow is FIG. 5 is terminated, which means that the flow goes to step S26 in FIG. 4. Since step S64 for the personal identification under the paring condition is carried out in parallel with the succeeding functions, the flow of FIG. 5 is terminated to advance to step S26 in FIG. 4 prior to the completion of the process in step S64. Accordingly, even in the course of the personal identification in step S64, it is possible to interrupt the personal identification by an operation to stop the function of assisting APP which is checked in step S26 if necessary. On the other hand, if it is not determined in step S62 that the pairing condition between cellular phone 4 and assist appliance 2 is established, the flow goes to step S66 for carrying out personal identification by means of cellular phone 4, and then the flow is FIG. 5 is terminated, which also means that the flow goes to step S26 in FIG. 4. Since step S66 for the personal identification by means of cellular phone 4 is carried out in parallel with the succeeding functions, the flow of FIG. 5 is terminated to advance to step S26 in FIG. 4 prior to the completion of the process in step S66. Both steps S64 and S66 each include the parallel function in cooperation with personal identification server 6, the detail of which will be explained later.

On the contrary, if it is not determined in step S58 that an operation is done at operation part 38 to activate the assisting APP, the flow in FIG. 5 is to be instantly terminated. By the way, if it is not determined in step S60 that any reliable reference data of the conversation partner exists even if personal identification server 6 is additionally searched, the flow goes to step S68. In step S68, it is indicated that no reference data exists, and then the flow is FIG. 5 is terminated.

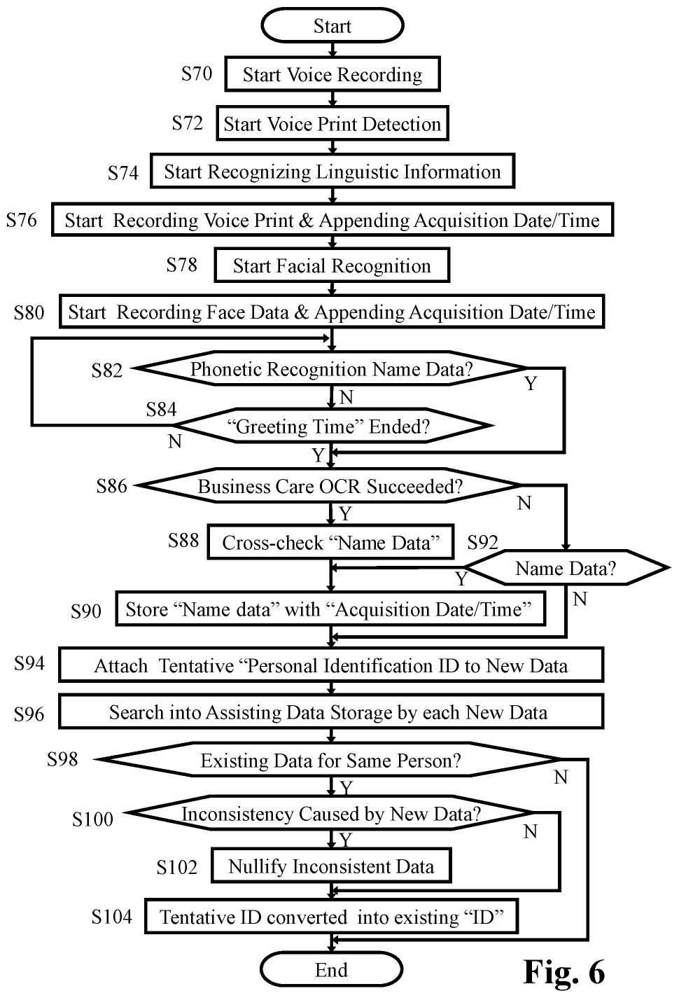

FIG. 6 represents a flowchart showing the details of the process of getting reference data of the conversation partner carried out in step S50 in FIG. 5. At the beginning of flow, the recording of the voice by means of microphone is started in step S70. In detail, the voice of conversation partner picked up by phone microphone 36b of cellular phone 4 or by appliance microphone 14 of assist appliance 2 starts to be recorded. If assist appliance 2 has already been used as the hearing aid, appliance microphone 14 has been in operation and ready to recording the voice at step S70. On the contrary, if phone microphone 36b of cellular phone 4 is to be used, phone microphone 36b is to be activated at step S70.

In parallel with recording the voice, the flow goes to step S72 to start detecting voice print based on the recorded voice. Further in parallel with above functions, the flow goes to step S74 to start recognizing the linguistic information based on the recorded voice. Still in parallel with the above functions, the flow goes to step S76 to start recording new voice print data if acquired through the voice print detection process started at step S72. Step S76 also starts to append the acquisition date/time to the recorded voice print data. The flow goes to step S78 still further in parallel with the above functions. The data acquired through step S76 corresponds to one of reference voice print data 52 in voice print database 44 shown in FIG. 2 and includes reference voice print data and the acquisition date/time data. Further discussion about the recording of the personal identification ID and the acquirer ID will be explained later.

In steps S78, rear-facing camera 37b of cellular phone 5 or appliance camera 12 assist appliance 2 is activated for capturing and recording the face image of the conversation partner to start facial recognition on the recorded face image data. In parallel with the above functions, the flow goes to step S80 to start recording new face data if acquired through the facial recognition process started at step S78. Step S80 also starts to append the acquisition date/time to the recorded face data. The flow goes to step S82 further in parallel with the above functions. The data acquired through step S80 corresponds to one of reference face data 54 face database 46 shown in FIG. 2 and includes reference face data and the acquisition date/time data. Further discussion about the recording of the personal identification ID and the acquirer ID will be explained later.

Steps S82 to S88 relate to acquisition of one of reference OCR data in OCR database 48 in FIG. 2. As has been mentioned, “OCR database 48” and “reference OCR data 56” represented in FIG. 2 shall be replaced with “name database 48” and “reference name data 56”, respectively, in the broad sense. In other words, the specific term “OCR data” in FIG. 2 is represented only as a typical case. Therefore, “OCR data” in FIG. 2 does mean not only “name data” derived from the business card by OCR, but also means “name data” derived from voice by phonetic recognition. In the latter case, “OCR data” as name data in FIG. 2 shall be replaced with “phonetic recognition name data”. Steps S82 to S88 explains both the cases of acquiring “name data” through phonetic recognition and through OCR as well as the cross-check between the name data gotten based on the two different cases.

In step S82, it is checked whether or not the “phonetic recognition name data” is extracted through the linguistic information recognizing process started at step S74. If no data is extracted at step S82, the flow advances to step S84 to check whether or not a predetermined time period, in which greetings are expected to be exchanged with self-introduction, has expired after the beginning of the conversation. If the predetermined time period has not expired at step S84, the flow goes back to step S82 to repeat steps S82 and S84 until the predetermined time period has expired. On the other hand, if the phonetic recognition name data is extracted at step S82 or the predetermined time period has expired at step S84, the flow advances to step S86. The advancement to step S86 by way of step S84 corresponds to a failure of extracting the phonetic recognition name data by reason that the name of the conversation partner has not been asked, or the conversation partner has not given her/his name voluntarily, or the like, during the predetermined time.

In step S86, it is checked whether or not the “name data” is extracted by means of OCR of the business card image data captured by rear-facing camera 37b of cellular phone 4 or captured by appliance camera 12 of assist appliance 2 and transmitted to cellular phone 4. Also in step S86, the recording of the voice for the phonetic recognition of the “name data” is stopped. If it is determined in step S86 that the “name data” is extracted by means of OCR of the business card image data, the cross-check of “name data” is executed in step S88 to go to step S90. If the “name data” based on the phonetic recognition and the “name data” based on OCR of the business card image data are inconsistent with each other, one of them of higher probability is adopted as the “name data” by means of a presumption algorithm in assisting APP 30. In detail, “name data” based on OCR of the business card is to be preferred unless the business card is blurred and illegible. By the way, if the flow comes to step S88 as the result that no “phonetic recognition name data” is extracted in step S82, step S90 follows with nothing occurs in step S88.

On the other hand, if no “name data” is extracted by means of OCR of the business card, the flow goes to step S92 to check whether or not any other “name data” has been obtained. And, if it is determined in step S92 that the “name data” based on the phonetic recognition is extracted, the flow goes to step S90.

In step S90, a process for storing the determined “name data” with its “acquisition date/time” attached is started and the flow advances to step S94 in parallel. The “name data” at step S90 corresponds to one of reference OCR data 56 (i.e., “reference name data” in the broad sense) stored in OCR database 48 (i.e., “name database” in the broad sense) shown in in FIG. 2. In other words, one of reference OCR data 56 (i.e., “reference name data” in the broad sense) with “acquisition date/time” is started to be stored in step S90. The manner of storing the acquirer ID will be explained later.

In step S94, under the condition that new reference data acquired through steps S76, S80 and S90 are from the same person, a tentative same “personal identification ID” is attached to those newly acquired reference data. The tentative “personal identification ID” to be attached can be optionally determined with respect to each person if the tentative “personal identification ID” is one and only within the same person. In this instance, such a case that OCR data (i.e., “name data” in the broad sense) is acquired in step S90, for example, means that reference OCR data 56 (i.e., “reference name data” in the broad sense) exists with tentative “personal identification ID” which is identical with one or both of reference voice print data 52 and reference face data 54 in FIG. 2. Accordingly, if voice print data or face data of a meeting again conversation partner is newly acquired and existing reference voice print data 52 or reference face data 54 matching the newly acquired data will be successfully searched, corresponding reference OCR data 56 (i.e., “reference name data” in the broad sense) can be called up to inform of the name of the meeting again conversation partner by means of mediation of the same tentative “personal identification ID” (which can be totally converted into existing “personal identification ID” with the identity of the person kept). On the other hand, if OCR data 56 (i.e., “name data” in the broad sense) cannot be acquired in step S90, a same tentative “personal identification ID” is attached only to reference voice print data 52 or reference face data 54. In this case, it is impossible to call up any corresponding reference OCR data 56 (i.e., “reference name data” in the broad sense) merely from newly acquired reference voice print data 52 or reference face data 54 since there exists no OCR data 56 (i.e., “name data” in the broad sense) with any same tentative “personal identification ID” attached.

Nest, in step S96, a search within assisting data storage 32 is done by each of the newly acquired reference data, respectively. And, in step S98, it is further checked whether or not an existing reference data of probably same person already contained in assisting data storage 32. Specifically, for example, a search within assisting data storage 32 is done for an existing reference voice print data 52 or reference face data 54 of probably same person as the person from whom the voice print data or the face data is newly acquired. Further, a search is done for an existing reference OCR data (i.e., “reference name data” in the broad sense) of the same text data as that of newly acquitted OCR data (i.e., “name data” in the broad sense).

If the check in step S98 succeeds in finding an existing reference data of probably same person as the person from whom the reference data is newly acquired, the flow advances to step S100 to check whether or not probability of the finding as to the newly acquired reference data causes inconsistency with other existing reference data within assisting data storage 32 in view of the identity of the person. An example of the inconsistency is that newly acquired voice print data coincides with a plurality of reference voice print data 52 each corresponding to a plurality of “personal identification ID's” of different persons, respectively. (Similar inconsistency may occur with respect to face data.) Another example of the inconsistency is that new voice print data acquired from a person coincides with an existing reference voice print data 52 corresponding to a first “personal identification ID”, for all that new face data acquired from the same person coincides with an existing reference face data 54 corresponding to another “personal identification ID” of a different person. Still another example of the inconsistency is that voice print data or face data newly acquired from a person does not coincide with an existing reference voice print data or existing reference face data corresponding to an existing reference OCR data (i.e., “reference name data” in the broad sense) for all that an OCR data (i.e., “name data” in the broad sense) newly acquired from the same person coincides with the existing reference OCR data (i.e., “reference name data” in the broad sense)

If any inconsistency is detected in step S100, the flow advances to step S102 to nullify at least one the inconsistent data, the flow then goes to step S104. In this case, the nullified data in step S102 is determined by means of the presumption algorithm in application storage 30. Usually the newly acquired reference data is to be nullified while the existing reference data is left for the purpose of keeping consistence among existing reference data. However, in such a special case that a change in existing reference data system is highly reasonable in view of improvement, the newly acquired reference data is preferred to the existing inconsistent reference data on the condition that the change will not destroy the existing reference data system in cognitive assisting data storage 32. In any way, the at least one of the inconsistent existing reference data is nullified in step S102 to go to step S104. On the other hand, if no inconsistency is detected in step S100, the newly acquired reference data is added to cognitive assisting data storage 32 and the flow goes to step S104.

In step S104, the tentative “personal identification ID” is converted into one of existing “personal identification ID” if it is determined that the tentative “personal identification ID” is of the same person as the person corresponding the existing “personal identification ID”. And the flow in FIG. 6 goes to the end. It should be noted that the existing “personal identification ID” is for one and only person which is attached to reference data uploaded to the personal identification server under the control on the side of the server with duplication avoided. Thus, the same existing “personal identification ID” is attached to a plurality of reference data uploaded from different persons, respectively, as long as all the plurality of reference data are of an identical person. On the contrary, “personal identification ID” is newly created and attached to an uploaded reference data if it is of a new person different from any one corresponding to existing “personal identification ID” within the personal identification server. The new “personal identification ID” is unaltered once created, and continuously used as existing “personal identification ID” for the new person. Accordingly, variety of reference data for a specific person can be uploaded to the personal identification server from numbers of different persons who get acquainted with the specific person in various occasions, which will improve the precision of identifying the specific person. On the other hand, if it is not determined in step S98, that an existing reference data of probably same person is already contained in assisting data storage 32, the tentative “personal identification ID” is maintained at the moment, the flow then going to the end.

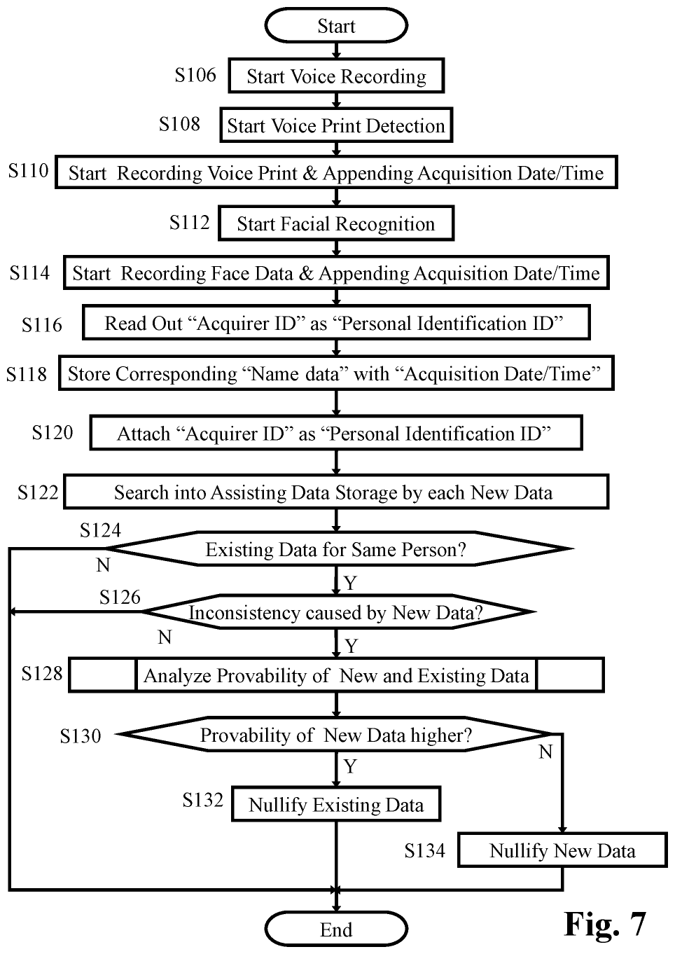

FIG. 7 represents a flowchart showing the details of the process for getting own reference data carried out in step S48 in FIG. 5. If the flow starts, in the same manner as in FIG. 6, the recording of the voice by means of microphone is started in step S106. In parallel with recording the voice, the flow goes to step S108 to start detecting voice print based on the recorded voice. In the case of getting own reference data, it should be noted that the name data is known, which is the reason why a step of recognizing the linguistic information based on the recorded voice such as step S74 in FIG. 6 is omitted in FIG. 7. Thus, the flow advances to step S110 for starting to record voice print data the acquisition date/time append. Further explanation of steps S110 to S114 is skipped here since these steps correspond to steps S76 to S80 in FIG. 6, respectively, and can be easily understood in the same manner.

The flow goes from step S114 to step S116, which corresponds to steps S82 to S88 in terms of the purpose of getting the name data. However, as has been pointed out above, the name data has been already known since it is own name. In other words, “personal identification ID” is identical with “acquirer ID”. Thus, what should be done in step S116 for the purpose of getting name data is to read out “acquirer ID” of the reference data. And in step S118, in the same manner as in step S90 in FIG. 6, a process for storing the determined “name data” with its “acquisition date/time” attached is started. In the case of S118, however, the determined “name data” corresponds to “acquirer ID”.

Next, in step S120, “acquirer ID” is adopted as “personal identification ID” which is attached to new reference data acquired through steps S110, S114 and S118. Step S120 basically corresponds to step S94 in FIG. 6. However, in the case of step S120, attached “personal identification ID” is not tentative, but corresponds to one of existing “personal identification ID” because “acquirer ID” adopted as “personal identification ID” in this case is known and fixed. Then, the flow goes to step S122. Steps S122 to S126 are similar to steps S96 to S100, the explanation of which is omitted.

In the case of the flow in FIG. 7, however, if it is determined in step S126 that probability of the finding as to the newly acquired reference data causes inconsistency. If any, the flow advances to step S128 to analyze probability of the finding as to the newly acquired reference data in comparison with that as to the existing reference data. In the case of own reference data, no inconsistency will be normally caused between “personal identification ID” of voice print data and “personal identification ID” of face data both acquired from an identical person. However, due to an internal cause such as a change in voice suffered from a cold, or due to an external cause such as a case of getting voice with low sensitivity or under harmful noise, reliability or quality of own voice print data may become insufficient. Similarly, reliability or quality of own face data may become insufficient due to low resolution or low illumination of face image. In such bad conditions, it may difficult to identify new own voice print data or new own face data in comparison with existing own voice print data or existing own face data in spite of all the data are acquired from same person. Or otherwise, the new own voice print data or new own face data is mistaken for data acquired from another person. Step S128 for checking whether or not probability of the finding as to the newly acquired reference data causes inconsistency with existing reference data is provided for solve the above mentioned problem in the bad conditions, and functions as the presumption algorithm in application storage 30.

Step S130 follows the above explained step S128, and checks whether or not the analyzed provability of the finding as to the new reference data is higher than that as to the existing reference data. And, if it is determined that the provability of the finding as to the new reference data is higher than that as to the existing reference data, the flow goes to step S132 to nullify the existing reference data which is inconsistent with the new reference data, the flow then going to the end. On the contrary, if it is determined that the provability of the finding as to the existing reference data is higher than that as to the new reference data, the flow goes to step S134 to nullify the new reference data which is inconsistent with the existing reference data, the flow then going to the end.

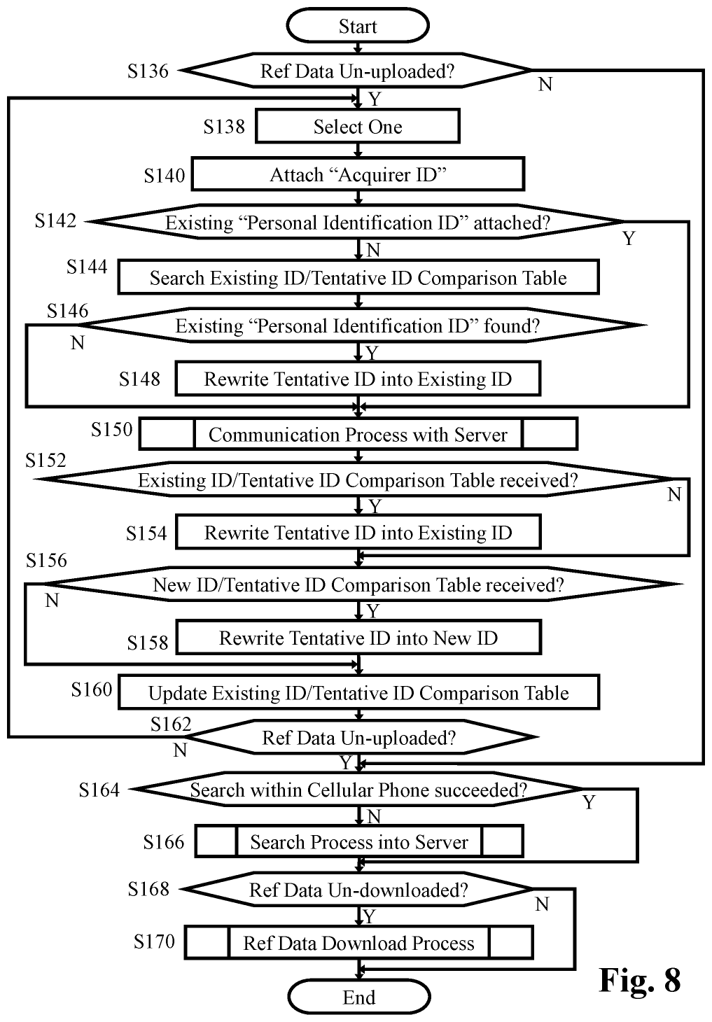

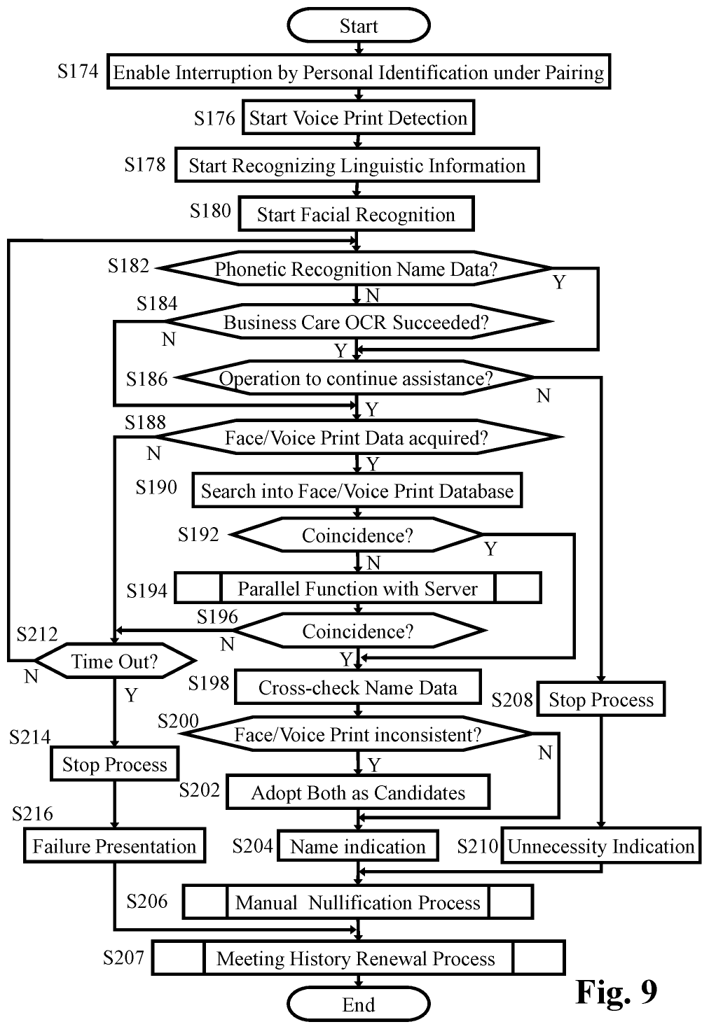

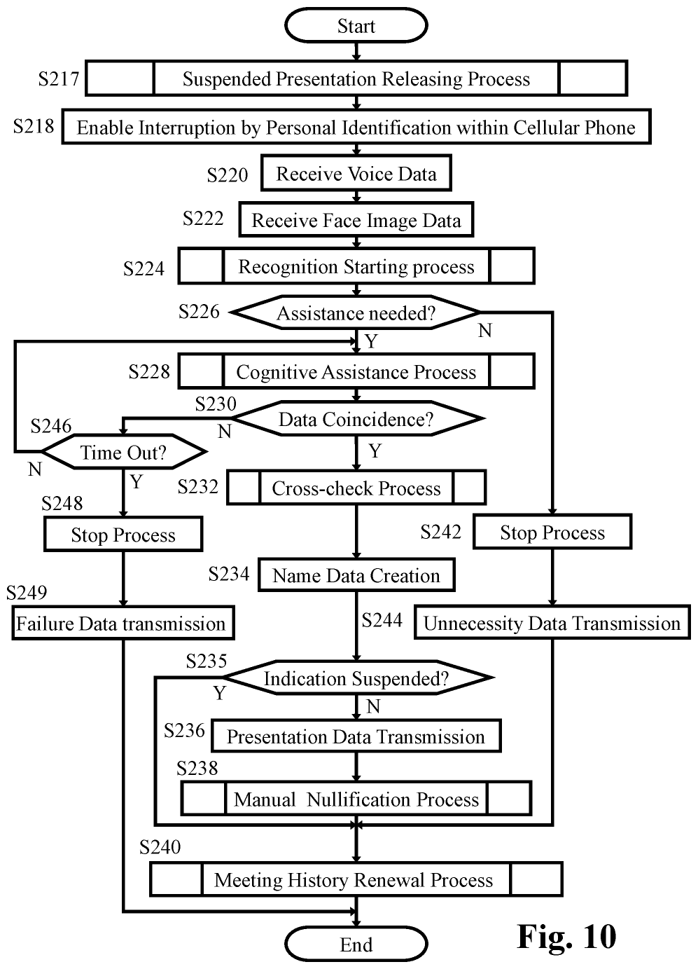

FIG. 8 represents a flowchart showing the details of the parallel function in cooperation with personal identification server 6 carried out in step S36 or S52 in FIG. 5. As has been explained above, the parallel function includes the upload of the reference data into personal identification server 6, the download of the reference data from personal identification server 6, and the search for the reference data based on the gotten data, FIG. 8 being for explaining these functions in detail. The parallel function in FIG. 8 is also carried out in personal identification by means of cellular phone to be explained in FIG. 9 and in personal identification under the paring condition to be explained in FIG. 10. Therefore, the following explanation of FIG. 8 is given with the function in FIGS. 9 and 10 also taken into consideration in advance.

Steps S136 to 162 correspond to the upload of the reference data into personal identification server 6. On the other hand, steps S164 to 166 correspond to the search for the reference data based on the gotten data. Finally, steps S168 to 170 correspond to the download of the reference data from personal identification server 6,

At the beginning of flow, it is checked again in step S136 whether or not any reference data gotten by cellular phone 4 has not been uploaded into personal identification server 6. Step S136 is to skip the reference data uploading process in steps S138 to S162 in case of no necessity for uploading the reference data through the parallel function in FIG. 8. However, if it is determined in step S136 that any reference data gotten by cellular phone 4 has not been uploaded into personal identification server 6, the flow advances to step S138.

In step S138, one reference data, which has not been uploaded into personal identification server 6, is selected. And, in step S140, “acquirer ID” is attached to the selected reference data. Thus, “acquirer ID” is attached to the reference data in the occasion of uploading the reference data for the identification server 6 to identify the person who uploads the reference data. Next in step S142, it is checked whether or not existing “personal identification ID” is attached to the reference data to be uploaded. If it is determined in step S142 that existing “personal identification ID” is not attached to the reference data to be uploaded, the flow goes to step S144 to conduct a search into “existing personal identification ID/tentative personal identification ID comparison table”. This comparison table shows the combination of “acquirer ID” and tentative “personal identification ID” in relation to corresponding existing “personal identification ID”. Since a tentative “personal identification ID” can be freely given by any person, an acquirer may give a tentative “personal identification ID” which is in duplicate with a tentative “personal identification ID” accidentally given by another independent acquire. However, by means of combining tentative “personal identification ID” with “acquirer ID”, one and only person can be identified as corresponding to existing “personal identification ID”. Although complete information of “Existing personal identification ID/tentative personal identification ID comparison table” is managed by personal identification server 6, a part of information limited to the same “acquirer ID” can be downloaded by the person identified by the “acquirer ID” for keeping privacy. The search conducted in step S144 is made within cellular phone 4 for such a partial “Existing personal identification ID/tentative personal identification ID comparison table” admitted to be downloaded and stored into cognitive assisting data storage 32.

Step S146 is for checking the result of the search conducted in step S144. If it is determined in step S146 that an existing “personal identification ID” corresponding to a combination of tentative “personal identification ID” and “acquirer ID” is found through the search, the flow goes to step S148 to rewrite the tentative “personal identification ID” into existing “personal identification ID”, the flow then advancing to step S150. On the other hand, the flow directly goes from step S146 to step S156 with the tentative “personal identification ID” kept in the case that no existing “personal identification ID” corresponding to a combination of tentative “personal identification ID” and “acquirer ID” is found. By the way, if it is determined in step S142 that existing “personal identification ID” is attached to the reference data to be uploaded, the flow directly goes from step S142 to step S150 because of no need of rewriting “personal identification ID”.

Step S150 is a process for uploading the reference data with the maintenance of “personal identification ID” done through steps S140 to 148 in cooperation with personal identification server 6. In the process in step S150, personal identification server 6 conducts a search into the complete “Existing personal identification ID/tentative personal identification ID comparison table” if reference data is uploaded with the tentative “personal identification ID” kept. And, if personal identification server 6 finds an existing “personal identification ID” corresponding to a combination of tentative “personal identification ID” and “acquirer ID”, personal identification server 6 rewrite the tentative “personal identification ID” into existing “personal identification ID”. Further in the process in step S150, personal identification server 6 informs cellular phone 4 of the relationship between the tentative “personal identification ID” and the existing “personal identification ID” rewritten. Similarly, in step S150, if a new “personal identification ID”, which is treated as existing “personal identification ID” afterwards, is assigned to the combination of tentative “personal identification ID” and “acquirer ID” by personal identification server 6 which fails in the search, cellular phone 4 is informed by personal identification server 6 of the relationship between the tentative “personal identification ID” and the existing “personal identification ID” newly assigned. The flow then advances to step S152.

In step S152, it is checked whether or not cellular phone 4 is informed by personal identification server 6 of the relationship between the tentative “personal identification ID” and the existing “personal identification ID” found through the search in response to the upload of reference data with the tentative “personal identification ID” kept. If the relationship is informed, the flow advances to step S154 to rewrite the tentative “personal identification ID” of the uploaded reference data into existing “personal identification ID” informed from cellular phone 4, the flow then going to step S156. On the other hand, if it is determined in step S152 that the relationship is not informed, the flow directly goes to step S156. In step S156, it is checked whether or not cellular phone 4 is informed by personal identification server 6 of the relationship between the tentative “personal identification ID” and the existing “personal identification ID” which is newly assigned in the case that personal identification server 6 fails in the search in response to the upload of reference data with the tentative “personal identification ID” kept. If it is determined in step S156 that the relationship is informed from personal identification server 6, the flow advances to step S158 to rewrite the tentative “personal identification ID” of the uploaded reference data into the newly assigned “personal identification ID”, which is treated as existing “personal identification ID” afterwards, the flow then going to step S160. On the other hand, if it is determined in step S156 that the relationship is not informed, the flow directly goes to step S160.

In step S160, maintenance of “tentative personal identification ID/existing personal identification ID comparison table” stored in cognitive assisting data storage 32 is done by means of adding the new relationship between the tentative “personal identification ID” and the existing “personal identification ID” informed from personal identification server 6, if any, which is determined through step S152 or step S156. As the processes on the side of personal identification server 6 in relation with step S150, the tentative “personal identification ID” of the uploaded reference data is rewritten into existing “personal identification ID” in personal identification server 6 in parallel with step S154 and step S158 of cellular phone 4, and maintenance of “tentative personal identification ID/existing personal identification ID comparison table” (which is stored within personal identification server 6 as a complete database including reference data from all the acquirer) is done in parallel with step S160 of cellular phone 4.

The flow then goes to step S162 to check whether or not any reference data gotten by cellular phone 4 is left un-uploaded into personal identification server 6. If any, the flow goes back to step S138 to select next one reference data which has not been uploaded into personal identification server 6. Thus, the loop of steps S138 to step S162 is repeated to upload the reference data one by one to personal identification server 6 in every repetition of the loop unless it is determined in step S162 that no reference data gotten by cellular phone 4 is left un-uploaded into personal identification server 6. As a modification of the process in steps S138 to S162, it may be possible to rewrite the tentative “personal identification ID” of all the reference data into existing “personal identification ID” in advance to uploading, respectively, by means of the search into the partial “Existing personal identification ID/tentative personal identification ID comparison table”, and then to upload all the reference data into personal identification server 6 in a lump, in place of rewriting the “personal identification ID” of the reference data and uploading the reference data one by one.

If it is determined in step S162 that no reference data gotten by cellular phone 4 is left un-uploaded into personal identification server 6, the flow goes to step S164. Also, if it is determined in step S136 that no reference data gotten by cellular phone 4 has not been uploaded into personal identification server 6, the flow directly goes to step S164 with steps S138 to S162 skipped. In step S164, it is checked whether or not final personal identification has been successful within the realm of cellular phone 4 alone or in cooperation with assist appliance 2. If unsuccessful, the flow goes to step S166 to carry out server search process in cooperation with personal identification server 6, and then advancing to step S168. The detail of the server search process will be explained later as the function of personal identification server 6. Since the server search process in step S166 is a parallel function, the flow advances to step S168 without waiting for the end of step S166. On the other hand, if it is determined in step S164 that final personal identification has been successful within the realm of cellular phone 4 alone or in cooperation with assist appliance 2, the flow directly goes to step S168. The final personal identification within the realm of cellular phone 4 alone or in cooperation with assist appliance 2 will be explained later in detail.

In step S168, it is checked whether or not any reference data uploaded to personal identification server 6 by others is left un-downloaded to cellular phone 4 from personal identification server 6. If any, the flow goes to step S170 to carry out reference data downloading process, the flow then going to the end of the flow. Since the reference data downloading process 170 is of a parallel function, the flow goes to the end without waiting for the end of step S170. In other words, the flow goes from step S170 in FIG. 8 to step S38 or step S58 in FIG. 5 without waiting for the end of step S70. In step S170, among all the new reference data uploaded from others, such a limited reference data is allowed to be downloaded that the limited reference data is uploaded by a specific person with “personal identification ID” which is attached to reference data uploaded by the user of cellular phone 4 (e.g., reference data of an acquaintance of the user of cellular phone 4 through direct meeting or video phone). Thus, privacy of any person is kept with her/his reference data prevented from spreading to unknown person (e.g., to the user of cellular phone 4 with whom the person is not acquainted, in this case) by way of personal identification server 6.

FIG. 9 represents a flowchart showing the details of the cellular phone personal identification process in step S66 in FIG. 5 carried out by cellular phone 4. If the flow starts, step S174 enables the interruption for executing the personal identification under the paring condition, the flow then going to step S176. Accordingly, the flow in FIG. 9 is interruptible any time during execution thereof to go to the personal identification process under the paring condition in step S64 in FIG. 5 if the pairing between cellular phone 4 and assist appliance 2 is established. The details of the personal identification process under the paring condition in step S64 is to be explained later.

In step S176, the detection of voice print based on the recorded voice is started. Further in parallel with above functions, the flow goes to step S178 to start recognizing the linguistic information based on the recorded voice. Still in parallel with the above functions, the flow goes to step S180 to start the facial recognition process. These functions are similar to the functions in steps S72, S74 and S78 in FIG. 6, respectively. It should be noted that nothing occurs in steps, S176, S178 and S180 if the above function has been already started through the process of getting reference data of the conversation partner carried out in step S50, for example.

Steps S182 to S186 are to check whether or not cognitive assistance is necessary by means of searching reference data. First, in step S182, it is checked whether or not “name data” of conversation partner is successfully acquired through phonetic recognition. If not, the flow goes to step S184 to check whether or not “name data” of conversation partner is acquired through OCR of the business card presented by the conversation partner. If “name data” of conversation partner is successfully acquired through OCR of the business card, the flow goes to step S186. On the other hand, If “name data” of conversation partner is successfully acquired through phonetic recognition, the flow directly goes to step S186. The case of the flow coming to step S186 ordinarily means that no cognitive assistance is necessary any more since the user of cellular phone 4 must have come to know the name of the conversation partner due to the self-introduction and/or presentation of the business card. However, in case of inaudible self-introduction or illegible business card or any other reason, it may be necessary for the user of cellular phone 4 to continue relying on further cognitive assistance. Step S186 is provided for such a case, and checks whether or not an operation is done at manual operation part 38 to continue the cognitive assistance. And, if such an operation is determined within a predetermined time in step S186, the flow goes to step S188. Further, if it is determined in step S184 that “name data” of conversation partner is not acquired through OCR of the business card, the flow automatically goes to step S188 since no “name data” is acquired through any of self-introduction and presentation of the business card.

In step S188, it is checked whether or not one of face data and voice print data or both of the conversation partner is successfully acquired. If any acquisition is successful, the flow goes to step S190 to search into cognitive assisting data storage 32 to find reference face data or reference voice print data which coincides with the acquired face data and voice print data, respectively. And, in step S192, it is checked whether or not the acquired data coincides with any reference data. If step S192 fails to find any coinciding reference data, the flow goes to step S194 to execute the parallel function in S194 cooperative with personal identification server 6. The parallel function cooperative with personal identification server 6 corresponds to the process executed in the part of the flow at step S166 in FIG. 8, the details of which will be explained later as the function of personal identification server 6. The flow then goes to step S196 to check whether or not any coinciding reference data is found. If any, the flow goes to step S198. On the other hand, if it is determined in step S192 that the acquired data coincides with any reference data, the flow directly goes to step S196.

In step S198, a plurality of “name data” corresponding to a plurality of coinciding reference data are cross-checked, if any. I should be noted that nothing will occur in step S198 if only one coinciding reference data, which corresponds to only one “name data”, is found. The flow then goes to step S200 to check whether or not there is any inconsistency between “name data” corresponding to coinciding reference face data and “name data” corresponding to coinciding voice print reference data. If any, the flow goes to step S202 to adopt both the “name data” for choice by the user of cellular phone 4, the flow then going to step S204. On the other hand, if it is determined in step S200 that only one person is identified with no inconsistency between “name data” corresponding to coinciding reference face data and “name data” corresponding to coinciding voice print reference data, the flow directly goes to step S204.

In step S204, the plurality of “name data” adopted in step S202 or only one “name data” identified through step S200 are presented to the user of cellular phone 4 as the result of personal identification. The presentation of the “name data” in step S200 means one of the visual presentation by displaying the name on phone display 34 and audible presentation by announcing the name through phone speaker 36c or through an earphone connected to earphone jack 36d, or both the visual and audible presentations. In the case of audible presentation, the swing of conversation is monitored to analyze pattern of gaps in the conversation to predict a next gap during which the name is announced not to overlap the conversation.

In parallel with the presentation of the result of personal identification in step S204, the flow advances to step S206 for manual exclusion process of in inconsistent data. The process in step S206 is necessary in the case that the plurality of “name data” are presented for choice by the user of cellular phone 4, in which the user is to exclude “name” data which she/he thinks inappropriate by means of manual operation part 38. The data thus excluded will never be adopted as the reference data afterward. The result of the manual exclusion will influence on the server search. In other words, no reference data will be located in personal identification server 6 once the reference data is excluded through the search within cellular phone 4

The manual exclusion process in step S206 is to be instantly terminated if there is no reference data to be excluded. On the other hand, if there exists any reference data to be excluded, the process will be automatically terminated in response to the manual operation for the exclusion. If no manual operation is done within a predetermined time limit, the process in step S206 will be automatically terminated with the time limit expired following a brief reminder. In the case of the termination without manual operation, it may be possible that the plurality of “name data” will be presented again for choice by the user of cellular phone 4 through another personal identification process in the future. In any case, if the manual exclusion process in step S206 is over, the flow goes to step S207. On the other hand, if it is not determined within a predetermined time that an operation is done at manual operation part 38 to continue the cognitive assistance, the flow goes to step S208 to terminate the detection of voice/face recognition started through steps S176 to S180 since there is no necessity of personal identification any more for cognitive assistance. Further, in step S210, a presentation of information of the no necessity of further cognitive assistance is presented to the user of cellular phone 4, the flow then going to step A207. The presentation in step S210 includes one of the visual presentation and the audible presentation, or both the visual and audible presentations, as in the presentation in step S204.

In step S207, meeting history renewal process is carried out. The meeting history renewal process is to accumulate history of meeting with the same person through every occasion of personal identification of the person on a person-by-person basis. In more detail, various data are accumulated as meeting history through every occasion of meeting, such as data of meeting person, meeting date and time, and meeting opportunity (direct meeting or video meeting, or phone conversation) gotten through the personal identification process, as well as data of meeting place gotten through GPS system 40 of cellular phone 4, or through rear-facing camera 37b of cellular phone 4 or appliance camera 12 of assist appliance 2 which captures image of distinguished buildings given over to image recognition. Since step S207 is carried out in parallel with the succeeding functions, the flow in FIG. 9 ends and the flow goes to step S26 in FIG. 4 prior to the completion of the meeting history renewal process.

On the other hand, if it is determined in step S188 that none of face data and voice print data of the conversation partner is acquired, or, if it is determined in step S196 that no coinciding reference data is found, the flow goes to step S212. In step S212 it is checked whether or not a predetermined time has passed since the detection of voice/face recognition was started through steps S176 to S180. If not, the flow goes back to step S182. And, the loop from step S182 to S212 by way of step S188 or step S196 is repeated unless it is determined in step S212 that the predetermined time has passed, in which the progress in personal identification at step S192 or at step S196 is waited. On the other hand, if it is determined in step S212 that the predetermined time has passed, the flow goes to step S214 to terminate the detection of voice/face recognition started through steps S176 to S180. And, in the next step S216, a presentation of failure in personal identification is presented to the user of cellular phone 4. The presentation in step S216 includes one of the visual presentation and the audible presentation, or both the visual and audible presentations, as in the presentation in steps S204 and S210.

FIG. 10 represents a flowchart showing the details of the personal identification process under the paring condition in step S64 in FIG. 5 carried out by cellular phone 4. If the flow starts, suspended personal identification presenting process is carried out in step S217. This process is necessary for such a cellular phone user who may think it impolite to take an action for confirming the result of personal identification in instant response to the success thereof before the presence of the conversation partner. In other words, the process in step in S217 makes it possible for the user to confirm the personal identification in relaxed manner with the conversation partner gone after the meeting. In reality, the process in step S217 firstly reminds the user of the fact that the user has ever suspended some personal identification, the reminder made by means of a chime or a vibration, and secondary presents the contents of the result of the suspended personal identification if the user responds to the reminder with manual operation part 38 within a predetermined time period. In detail, since the personal identification process is carried out under the paring condition in the case of FIG. 10, suspension of transmitting presentation data of the contents of the result of the personal identification is released in response to a handling of manual operation part 38 for instantly transmitting the presentation data to assist appliance 2 for browse. How to suspend the transmission of presentation data of the contents of the result of the personal identification is to be explained later. In FIG. 10, the suspension of transmitting presentation data of the contents of the result of the personal identification and its release for browse is explained as the function within the personal identification process under the paring condition. However, similar function of the suspension and its release is also applicable to the personal identification by means of cellular phone in FIG. 9. Especially in the case of the personal identification by means of cellular phone, the use has to browse the contents of the result of the personal identification on phone display 34 of cellular phone 4 with her/his head bended down, which may be impolite as a behavior during conversation. Thus, the function of suspending the browse of contents of the result of the personal identification and its release may also be a great help in the personal identification by means of cellular phone. Since step S217 is carried out in parallel with the succeeding functions, the flow goes to step S218 prior to the completion of the suspended personal identification presenting process.

Step S218 enables the interruption for executing the personal identification by means of cellular phone, the flow then going to step S220. Thus, it is possible to interrupt the personal identification process under the paring condition in FIG. 10 for jumping to the personal identification by means of cellular phone in step S66 in FIG. 5

In step S220, cellular phone 4 receives the voice data for use in extracting the voice print and in recognizing the linguistic information from assist appliance 2. Next, in step S222, cellular phone 4 receives the face image data for use in facial recognition. These functions are carried out in parallel with the function of appliance camera 12 for capturing the face image of the conversation partner and the function of appliance microphone 14 for getting the voice of the conversation partner. Further, in parallel with the receipt of the voice data and the face image data, the flow goes to step S224 to carry out the recognition starting process. Detailed explanation of step S224 is omitted since the recognition starting process therein corresponds to steps S176 to S180 in FIG. 9. Also in parallel with the recognition function started in step S224, the follow goes to step S226 to check whether or not the current status is in need of cognitive assistance. Detailed explanation of step S226 is omitted since the checking function therein corresponds to steps S182 to S186 in FIG. 9.

If it is confirmed in step S226 that the current status is in need of cognitive assistance, the flow goes to step S228 to carry out cognitive assistance. Explanation of Step S228 is omitted since step S228 is substantially equal to steps S188 to S194 in FIG. 9. And, the flow advances to step S230 to check whether or not the acquired data coincides with any reference data. Step S230 corresponds to step S196, and also to step S192 both in FIG. 9. If it is determined in step S230 that the acquired data coincides with any reference data, the flow goes to step S232 for carrying out cross-check process. Explanation of Step S232 is omitted since step S2232 is substantially equal to steps S198 to S202 in FIG. 9. Following the above process, the flow goes to step S234 to create presentation data of the “name data” for presentation in assist appliance 2 as the result of the personal identification. The presentation data includes one of the visual presentation data for displaying the name on visual field display 18 and audible presentation data by announcing the name through stereo earphone 20, or both the visual and audible presentations.

The flow then goes to step S235 to check whether or not such a manual operation is made within a predetermined time period that the presentation of the created presentation data of the “name data” is to be suspended. In detail, in step S235, the user is informed of the fact that the personal identification is successful by means of a vibration of cellular phone 4 or by means of transmission of the information of the fact to assist appliance 2 causing a simple display on visual field display 18 or for generation of chime sound from stereo earphone 20. Further in step S235 it is checked whether or not the user responds to the information with operating manual operation part 38 within the predetermined time period for indicating intent of the user to suspend the presentation of the created presentation data of the “name data”. If no operation is determined in step S235 within the predetermined time period, the flow goes to step S236 to transmit the presentation data of the “name data” created in step S234 to assist appliance for making it possible to instantly present the presentation data of the “name data”, the flow then going to step S238 and further to step S240. Explanation of steps S238 and S240 is omitted since steps S238 and S240 are substantially equal to steps S206 and S207 in FIG. 9.

On the other hand, if any operation for suspending the presentation of the presentation data of the “name data”, the flow goes to step S240. In other words, the transmission of the presentation data of the “name data” is not carried out, but the presentation is suspended in this case. As has been explained above with respect to step S217, such a suspension of the presentation of the result of personal identification is also applicable to the personal identification by means of cellular phone in FIG. 9. For better understanding the case of application to the flowchart in FIG. 9, however, it should be noted that “Presentation data transmission” of step S236 shall be replaced with “Presentation on Phone Display 34”.

By the way, if it is determined in step S226 that the current status is in no need of cognitive assistance, the flow goes to step S242 to terminate the detection of voice/face recognition started through steps S224. Further, in step S244, a presentation data indicative of no necessity of further cognitive assistance is transmitted to assist appliance 2, the flow then going to step S240. The presentation data transmitted in step S244 includes one of visual presentation data and the audible presentation data, or both the visual and audible presentation data.

Further, if it is not determined in step S230 that the acquired data coincides with any reference data, the flow goes to step S246 to check whether or not a predetermined time has lapsed after the recognition process was started in step S224. If the time lapse has not determined yet in step S224, the flow goes back to step S226. And, the loop from step S226 to step S246 by way of step S230 is repeated unless it is determined in step S246 that the predetermined time has lapsed, wherein any progress at step S226 or step S230 is waited during the repetition or the loop. If it is determined in step S246 that the predetermined time has lapsed the flow goes to step S248 to terminate the detection of voice/face recognition started through steps S224. Further, in step S249, a presentation data indicative of impossibility of cognitive assistance is transmitted to assist appliance 2, the flow then going to the end. The presentation data transmitted in step S249 includes one of visual presentation data and the audible presentation data, or both the visual and audible presentation data.

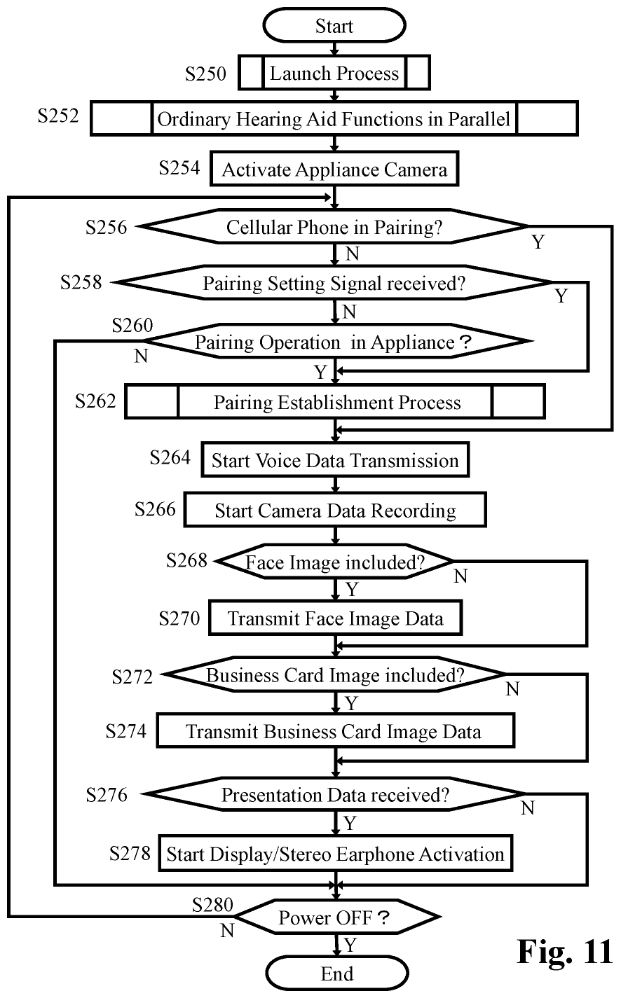

FIG. 11 represents a basic flowchart showing the function of appliance controller 8 of assist appliance 2 according to the embodiment shown in FIGS. 1 and 2. The flow starts in response to turning-on of assist appliance 2 and launches assist appliance 2 in step S250. Further in step S252, process for ordinary functions as the hearing aid, which is to be carried out in parallel with the functions as assist appliance 2 according to the present invention, is started, the flow then going to step S254 to activate appliance camera 12. Appliance camera 12 is to be utilized to capture face of conversation partner for cognitive assistance. Appliance camera 12 is further capable of ordinarily shooting various surroundings as still or moving image for the sake of remembrance, or is capable of capturing distinguished buildings for the sake of getting positional data.

Next in step S256, it is checked whether or not the pairing condition between cellular phone 4 and assist appliance 2 is established. If the pairing condition is not determined in step S256, the flow goes to step S258 to check whether or not such a pairing setting signal is received from cellular phone 4, the paring setting signal indicating that a manual operation is done at operation part 38 for setting the pairing between cellular phone 4 and assist appliance 2. If not, the flow goes to step S260 to check whether or not a manual operation is done on the side of assist appliance 2 for setting the pairing between cellular phone 4 and assist appliance 2. If the manual operation on the side of assist appliance 2 is determined, the flow goes to step S262 to establish the pairing condition between cellular phone 4 and assist appliance 2, and then the flow going to step S264. Further, if it is determined in step S258 that the pairing setting signal is received, the flow also goes to step S262, and then the flow going to step S264. On the other hand, if it is determined in step S256 that the pairing condition between cellular phone 4 and assist appliance 2 has already established, the flow directly goes to step S264.

If it is confirmed that the pairing condition between cellular phone 4 and assist appliance 2 is established through steps S256 to S262, the flow goes to step S264 to start transmission of the voice data gotten by appliance microphone 14 to cellular phone 4. Next in step S266, image data captured by camera 12 is started to be recorded. And, in step S268, it is checked whether or not the recorded image data is face data. If the camera data is face data, the flow advances to step S270 to transmit the face data to cellular phone 4, then the flow goes to step S272. On the other hand, if it is not determined in step S268 that the recorded image data is face data, the flow directly goes to step S272.

In step S272, it is checked whether or not the recorded image data is business card image data, the flow advances to step S270 to transmit the business card image data to cellular phone 4, then the flow goes to step S276. On the other hand, if it is not determined in step S272 that the recorded image data is the business card image, the flow directly goes to step S276. Thus, step S254 and steps S268 to S274 generally relate to function to transmit the data of the conversation partner acquired by assist appliance 2 to cellular phone 4.

In step S276, it is checked whether or not a presentation data relating to personal identification is received from cellular phone 4. As mentioned above, the presentation data includes the visual presentation data and/or the audible presentation data indicative of one of a name for cognitive assistance, impossibility of cognitive assistance, and no necessity of further cognitive assistance. If any receipt of the presentation data is determined in step S276, the flow goes to step S278 to start the indication by means of visual field display 18 and/or stereo earphone 20, the flow then advances to step S280. In step S278, in detail, visual field display 18 is activated to display visual image of the name or other indication in the visual field of a user, and/or stereo earphone 20 is activated to audibly output the name or other indication from one of the pair of channels, for example. As an alternative way in the case of the audible presentation, the name or other indication can be started to audibly output from both the pair of channels of stereo earphone 20 during a gap of conversation detected or predicted as in the explanation above. On the other hand, if no receipt is determined in in step S276, the flow directly goes to step S280.

In step S280, it is checked whether or not assist appliance 2 is turned off. If it is not determined that assist appliance 2 is turned off, the flow goes back to step S256. Accordingly, the loop from step S256 to step S280 is repeated unless it is determined that assist appliance 2 is turned off in step S280. On the other hand, if it is detected in step S280 that the assist appliance 2 is turned off, the flow is to be terminated.

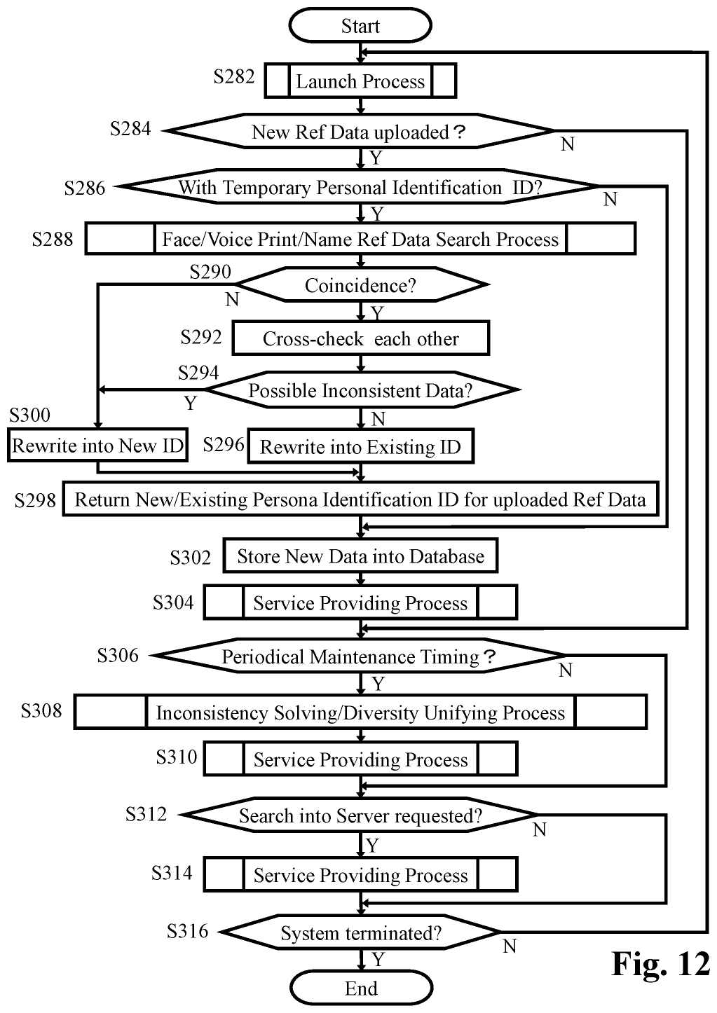

FIG. 12 represents a basic flowchart showing the function of server controller 42 of personal identification server 6 according to the embodiment shown in FIGS. 1 and 3. The flow starts by starting the personal identification and launches the entire system in step S282. Further in step S284, it is checked whether or not any reference data is newly uploaded from any of cellular phones. If any, the flow goes to step S286 to check whether or not the new reference data is uploaded with a tentative “personal identification ID”. In the case of new reference data with a tentative “personal identification ID”, the flow goes to search process in step S288 to search into voice print database 44, face database 46 and OCR database 48 for checking whether or not the new reference data with a tentative “personal identification ID” coincides with any one of reference data in the data base, the result being checked in the next step S290.

If it is determined in step S290 that the new reference data with a tentative “personal identification ID” coincides with one of reference data in the database, the flow goes to step S292. In step S292, in the case of a plurality of reference data in the database coinciding with the new reference data, the plurality of reference data are cross-checked with each other, the flow then going to step S294. In step S294 it is checked whether or not any reference data is possibly inconsistent with another. (An example of the inconsistency is as follows. Such a case is to be considered that a newly uploaded reference face data with a tentative “personal identification ID” coincides with a reference face data in the database and a newly uploaded reference voice print data with the same tentative “personal identification ID” coincides with a reverence voice print data in the database. In this case, if the coinciding reference face data in the database is related to an existing “personal identification ID” whereas the coinciding reverence voice print data in the database is related to another existing “personal identification ID”, a possible inconsistency occurs as the result of the cross-check because the two coinciding reference data are of different two persons in spite of the tentative “personal identification ID” of the same person.)

If no inconsistency is determined in step S294, the flow goes to step 296. It should be noted that if only one reference data in the database coincides with the new reference data in step 290, the flow goes to step S296 with nothing occurs in steps S292 and S294. In step S296, the tentative “personal identification ID” uploaded with the new reference data is rewritten into the existing “personal identification ID” of the coinciding reference data in the database, the flow then going to step S298.

On the other hand, if it is determined in step S290 that the new reference data with a tentative “personal identification ID” does not coincide with any of reference data in the database, the flow goes to step S300. Further, if it is determined in step S294 that the new reference data with a tentative “personal identification ID” coincides with a plurality of reference data in the database with possible inconsistency, the flow also goes to step S300. In step S300, the tentative “personal identification ID” uploaded with the new reference data is rewritten into a new “personal identification ID” which is to be treated afterward as existing “personal identification ID”, one and only in the database, the flow then going to step S298. By means of the rewrite in step S296 explained above with respect to various cases, there will be no confusion in existing “personal identification ID” in the database system. However, there may be such a possibility caused that a plurality of reference data each related to different existing “personal identification ID” although the plurality of reference data are derived from the same person. This possibility of duplicate assignment of plurality of existing “personal identification ID” to only one person will be gotten together by means of another process explained later.

In step S298, the existing “personal identification ID” found by the search or newly assigned in place of the tentative “personal identification ID” is sent back to cellular phone 4 of the person having “acquirer ID” who has uploaded the reference data with the tentative “personal identification ID”, the flow then going to step S302. By means of step S298, accordingly, the person who is carrying cellular phone 4 to upload the reference data with the tentative personal identification ID″ can be informed of the rewrite of the tentative “personal identification ID” into the existing “personal identification ID” at identification server 6. Thus, steps S152 to S160 in the flow of cellular phone 4 explained in FIG. 8 are facilitated. On the other hand, if it is determined in step S286 that the new reference data is uploaded not with a tentative personal identification ID″, but with an existing “personal identification ID”, the flow directly goes to step S302.

In step S302, the newly uploaded reference data with the existing “personal identification ID” originally attached, or the newly uploaded reference data with the existing “personal identification ID” found by the search or newly assigned in place of the tentative “personal identification ID” is stored into corresponding database in personal identification server 6. The flow then goes to step S304 for carrying out service providing process, the detail of which will be explained later. In brief, the service providing process includes the server search process and reference data delivery process, or the like. The reference data delivery process is to deliver the newly uploaded reference data to other interested and deserving persons, or to inform the interested and deserving persons of the update of the database in personal identification server 6. If the flow comes to step S304 by way of step S302, the reference data delivery process is carried out as the service providing process. In the reference data delivery process in step 304, such an infringement of privacy is carefully protected that “personal identification ID” may be searched and compromised by personal identification server 6 in response to a black-hearted upload of a face data gotten by spy photo. This will be explained later in detail. Since step S304 is carried out in parallel with the succeeding functions, the flow advances to step S304 prior to the completion of the reference data delivery process.

In step S306, it is checked whether or not periodical maintenance falls due to go to step S308 if on time. Step S308 is to exclude inconsistent reference data for avoiding confusion, and to unify a “personal identification ID” related to reference voice print data and another “personal identification ID” related to reference face data, for example, if it is determined highly probable that both the reference voice print data the reference face data are derived from the same person, in which the “personal identification ID” created later is changed to accord with the “personal identification ID” created in advance. If the process in step S308 is completed, the flow goes to the service providing process in step S310. In contrast with the service providing process in step S304, step S310 carries out the delivery of the newly uploaded reference data with the result of reference data exclusion and the unification of “personal identification ID” incorporated. Since step S310 is also carried out in parallel with the succeeding functions, the flow advances to step S312 prior to the completion of the reference data delivery process. On the other hand, if it is not determined in S306 that periodical maintenance falls due, the flow directly goes to step S312.

In step S312, it is checked whether or not a search in personal identification server 6 is requested by any one of cellular phones to go to the service providing process in step S314 in response to the request. In this case, a search in personal identification server 6 is carried as the service providing process. Since step S314 is also carried out in parallel with the succeeding functions, the flow advances to step S316 prior to the completion of the reference data delivery process. On the other hand, if it is determined in S312 that none of cellular phones request the search in personal identification server 6, the flow directly goes to step S316. In step S316, it is checked whether or not the entire system is terminated. If not, the flow goes back to step S284. Accordingly, the loop from step S284 to step S316 is repeated unless it is determined that the entire system is terminated in step S316, wherein various services are provided during the repetition or the loop. On the other hand, if it is detected in step S316 that the entire system is terminated, the flow is to be terminated.

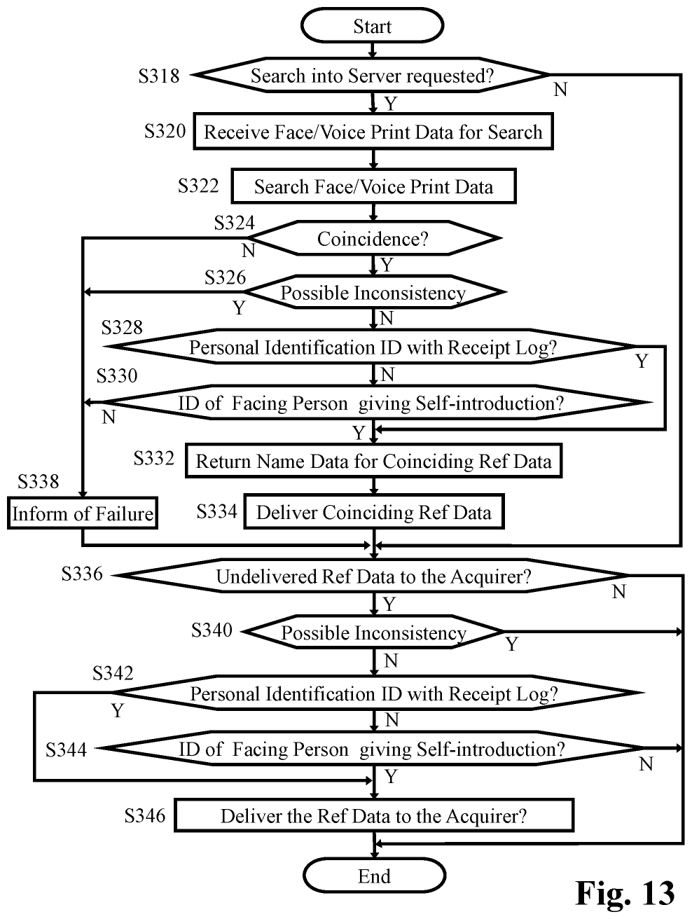

FIG. 13 represents a flowchart showing the details of the service providing process in steps S304, S310 and S314 in FIG. 12. If the flow starts, it is checked in step S318 whether or not a search in personal identification server 6 is requested. If the request is detected, the flow goes to step S320. This is the case that the flow advances from step S312 to step S314 in FIG. 12. In step S320, assist appliance 2 receives one of reference face data and reference voice print data, or both, of a person to be identified from cellular phone 4 requesting the service. Then, the flow advances to step S322 to search corresponding reference face data and/or reference voice print data in face database 46 and/or voice print database 44 to find one coinciding with the reference data received, the result being checked in the next step S324.

If it is determined in step S324 that the received data coincides with at least one of the reference data in the database, the flow goes to step S326. In step S326, in the case of a plurality of reference data in the database coinciding with the received reference data, it is checked whether or not the plurality of reference data include any probable inconsistency therein. If it is determined by means of cross-check in step S326 that the plurality of reference data include no inconsistency therein, the flow goes to step S328. By the way, if only one reference data in the database coincides with the received reference data, step S328 follows with nothing occurs in step S326.

In step S328, it is checked whether or not personal identification server 6 records such a log or history that the name data related to reference data in the database coinciding with the new data acquired and transmitted from a cellular phone in requesting the search has already been uploaded from the same cellular phone. This check is possible by means of searching all name data uploaded with “acquirer ID” corresponding to the user of the cellular phone requesting the search. On the basis of various data shown in FIG. 2, the case that personal identification server 6 records the log or history mentioned above is to be concretely explained. As an example, such a case is to be considered that a search is requested by cellular phone 4 with newly acquired voice print data (accompanied with “acquirer ID”, 412537, which identifies the user of cellular phone 4) transmitted to personal identification server 6, and the newly acquired voice print data (accompanied with “acquirer ID”, 412537) coincides with Voice Print 2 in data No. 2 (which is of a person identified by “personal identification ID”, 381295) recorded in voice print database 52 of personal identification server 6. In this case, the result to be transmitted back to cellular phone 4 is the name of the person identified by “personal identification ID”, 381295 corresponding to data No. 2 recorded in voice print database 52, which is however not acquired by the user of cellular phone 4 herself/himself, but by another person identified by “acquirer ID”, 521378. Fortunately, in this case, personal identification server 6 records such log or history that the person identified by “acquirer ID”, 412537 has already uploaded Face Feature 4 in data No. 4 recorded in face database 54 and Text 3 (e.g., name) in data No. 3 recorded in OCR database (e.g., name database) 56, both being of the person identified by “personal identification ID”, 381295. This means that the user of cellular phone 4 identified by “acquirer ID”, 412537 has already been acquainted with the person identified by “personal identification ID”, 381295 even if the user of cellular phone 4 suffers a lapse of memory of the name of the person. Thus, there is no problem in view of privacy if Text 3 (e.g., name) in data No. 3 for the person identified by “personal identification ID”, 381295 is to be transmitted back to cellular phone 4 identified by “acquirer ID”, 412537 even if the coinciding Voice Print 2 in data No. 2 is acquired by the another person identified by “acquirer ID”, 521378.

On the other hand, if it is not determined in step S328 that personal identification server 6 records any of the log or history discussed above, the flow goes to step S330. In step S330 it is checked whether or not the reference data in the database coinciding with the new data acquired and transmitted from a cellular phone in requesting the search is indicative of the “personal identification ID” of a conversation partner to whom the user of the cellular phone gives a self-introduction. On the basis of various data shown in FIG. 2, the reason why step S330 is inserted in the flow is to be concretely explained. As an example, such a case is to be considered that a search is requested by another cellular phone with newly acquired face data (accompanied with “acquirer ID”, 521378, which identifies the another user of the another cellular phone) transmitted to personal identification server 6, and the newly acquired face data coincides with Face Feature 2 in data No. 2 (which is of a person identified by “personal identification ID”, 381295) recorded in face database 54 of personal identification server 6. In this case, the result to be transmitted back to the another cellular phone if possible would be the name of the person corresponding to “personal identification ID”, 381295 in data No. 2 recorded in face database 54. However, Text 3 (e.g., name) in data No. 3 recorded in OCR database (e.g., name database) 56 corresponding to “personal identification ID”, 381295 is not acquired by the another user of the another cellular phone requesting the search with “acquirer ID”, 521378, but by the person identified by “acquirer ID”, 412537. And, this is the reason why the flow goes from step S328 to step S330. In other words, if the check in step S328 is negative, it may be generally possible that a black-hearted person acquiring face data of a target unacquainted person by spy photo accesses personal identification server 6 for requesting the search to know the name of the target unacquainted person. In this example, the another user requesting the search with “acquirer ID”, 521378 may be generally regarded as a black-hearted person. Step 330 is to save a special case of a possible well-intentioned person to be distinguished from the above mentioned conduct by the black-hearted person even if the check in step S328 is negative.

Further according to FIG. 2, there is the log or history in personal identification server 6 that the person identified with “personal identification ID”, 381295 also acquires Face Feature 1 in data No. 1 recorded in face database 54 and Text 1 (e.g., name) in data No. 1 recorded in OCR database (e.g., name database) 56, both being of the person identified by “personal identification ID”, 521378 at 12:56 on 2018/03/30 which is the same date/time at which the another person identified with “personal identification ID”, 521378 acquires Face Feature 2 in data No. 2 recorded in face database 54 of the person identified by “personal identification ID”, 381295. This means that the person identified with “personal identification ID”, 521378 supposedly gives a self-introduction to the person identified with “personal identification ID”, 381295 by means of showing a business card, which supposedly makes it possible for the person identified with “personal identification ID”, 381295 to acquire Text 1 in data No. 1 of OCR database 56 as well as Face Feature 1 in data No. 1 of database 54, both being of the person identified by “personal identification ID”, 521378. In other words, the person identified with “personal identification ID”, 381295 is the conversation partner of the person identified by “personal identification ID”, 521378. Thus, there is no problem in view of privacy if Text 3 (e.g., name) in data No. 3 for the person identified by “personal identification ID”, 381295 is to be transmitted back to the another cellular phone identified by “acquirer ID”, 521378 because the person identified by “personal identification ID”, 381295 has already given a return self-introduction supposedly with voice to the person identified with “personal identification ID”, 521378 at the beginning of the conversation. Step S330 is inserted in the flow to check whether or not the log or record relating to the above mentioned self-introduction is in the database for the purpose of saving the possible well-intentioned case such as the person with “personal identification ID”, 521378 discussed above.

If it is determined in step S330 that the “personal identification ID” found as the result of the search requested by the cellular phone corresponds to the “personal identification ID” of a conversation partner to whom the user of the cellular phone gives a self-introduction, the flow goes to step S332 to transmit back to the cellular phone the name of the person corresponding to the “personal identification ID” uploaded by another acquirer. On the other hand, if it is determined in step S328 that personal identification server 6 records such a log or history that the name data found by the search requested by the cellular phone has already been uploaded from the same cellular phone, the flow also goes to step S332 to transmit back to the cellular phone the name of the person corresponding to the “personal identification ID”.

Then the flow goes to step S334 to deliver to the cellular phone requesting the search the reference data in the database which coincides with the new data uploaded for requesting the search, the flow then going to step S336. By means of the delivery of the reference data through step S334, the cellular phone requesting the search will be able to utilize the received reference data in the next search within the cellular phone. On the other hand, if it is not determined in step S318 that any search in personal identification server 6 is requested, the flow directly goes to step D336. By the way, if it is not determined in step S324 that the received data coincides with at least one of the reference data in the database, or if it is determined in step S326 that the plurality of reference data include some probable inconsistency therein, or it is not determined in step S330 that the “personal identification ID” found as the result of the search corresponds to the “personal identification ID” of a conversation partner to whom the user of the cellular phone gives a self-introduction, the flow goes to step S338 to send back to the cellular phone the result of the requested search that no coinciding reference data is found, the flow then going to step S336. The above explained steps leading to step S336 corresponding to the details of service providing process in step S314 in FIG. 12.

Steps beginning with step S336 relate to the details of the reference data delivery process in the service providing process basically corresponding to steps S304 and S310 in FIG. 12. In step S336, it is checked whether or not any reference data remains undelivered to any person who has past record of uploading to personal identification server 6 some reference data with own “acquirer ID”. If any reference data remains, the flow goes to step S340 to check whether or not the remaining reference data is probably inconsistent with any other reference data by means of cross-check. If no inconsistency is determined, the flow goes to step S342 and to step S344. Steps S342 and S344 are for checking whether or not there is any possibility of the infringement of privacy caused by the delivery of reference data, the detail explanation of which is omitted since the checks therein are similar to those in steps S328 and S330.

As has been explained, in step S344 for the presumption relating to the self-introduction, voice print database 44 is also checked. For example, it can be checked according to database 44 in FIG. 2 that Voice Print 1 and Voice Print 3 of the same person identified with “personal identification ID”, 521378 were acquired on different opportunities, respectively, which caused the upload of data No. 1 by “acquirer ID”, 381295 and the upload of data No. 3 by “acquirer ID”, 412537. This means that the person identified with “personal identification ID”, 521378 gave self-introduction both to the person identified with “acquirer ID”, 381295 in data No. 1 and the person identified with “acquirer ID”, 412537 in data No. 3. Thus, there is no problem in view of privacy if Voice Print 1 and Voice Print 3 of the same person identified with “personal identification ID”, 521378 are shared by the person identified with “acquirer ID”, 381295 and the person identified with “acquirer ID”, 412537 each other, which makes it possible for the two persons to know the name of the person identified with “personal identification ID”, 521378 indexed by any of Voice Print 1 and Voice Print 3. In other words, the above example is so concluded through step S344 that data No. 1 can be delivered to the cellular phone of the person identified with “acquirer ID”, 412537 and data No. 3 can be delivered to the cellular phone of the person identified with “acquirer ID”, 381295. Since voice print data does not include real name of any person, but includes only “personal identification ID” and “acquirer ID”, the real name cannot be known unless OCR data, which discloses the relationship between “personal identification ID” and the real name, is sheared. Accordingly, such privacy that a first person who is acquainted with a second person is also acquainted with a third person is prevented from leaking through the sharing of the reference voice print data and/or the reference face data.

If it is determined in step S342, that the name data relating to the reference data in question has already been uploaded from the same cellular phone, or it is determined in step S344 that the check in view of self-introduction is affirmative, the flow goes to step S346 to deliver the relating reference data to the relating cellular phone, and the flow goes to the end. On the other hand, it is determined in step S336 that there is no reference data remains undelivered, or it is determined in step S340 that any remaining reference data is probably inconsistent with other reference data, or if the check in step S344 is negative, the flow directly goes to the end without delivery function.

The functions and the advantages of the present invention explained above are not limited to the embodiments described above, but are widely applicable to other various embodiments. In other words, the embodiment according to the present invention shows the system including assist appliance 2 of cognitive faculty incorporated in spectacles with hearing aid, cellular phone 4, and personal identification server 6. However, assist appliance 2 of cognitive faculty may be modified into another type which is not incorporated in spectacles with hearing aid. Further, assist appliance 2 may be omitted in such a case that necessary function discussed above is incorporated into the function of cellular phone 4. In this case, in detail, OCR data is acquired by means of phone camera 37 capturing the business card. Assisting APP 30 may be prepared in general application program (APP) catalog for general cellular phones and can be downloaded and installed according to ordinary manner of getting application program (APP). Further, the communication between cellular phone 4 and personal identification server to upload and download and share various reference data for personal identification is available according to ordinary manner of communication between general cellular phones and general servers.

The followings are summary of some features according to the above described embodiment.

The above described embodiment of this invention provides a cognitive faculty assisting system comprising a mobile user terminal and a server.

In detail, the mobile user terminal includes a terminal memory of names of persons and identification data for identifying the persons corresponding to the names as reference data; a first acquisition unit of the name of a person for storage in the memory, wherein the first acquisition unit acquires the name of the person on an opportunity of the first meeting with the person; a second acquisition unit of identification date of the person for storage in the memory, wherein the first acquisition unit acquires the identification data of the person as the reference data on the opportunity of the first meeting with the person, and acquires the identification data of the person on an opportunity of meeting again with the person; an assisting controller that compares the reference data with the identification data of the person acquired by the second acquisition unit on the opportunity of meeting again with the person to identify the name of the person if the comparison results in consistency; a display of the name of the person identified by the assisting controller in case a user of the mobile user terminal hardly reminds the name of the person on the opportunity of meeting again with the person; and a terminal communicator that transmits the identification data of the person corresponding to the name of the person as reference data, and receives for storage the identification data of the person corresponding to the name of the person as reference data which has been acquired by another mobile user terminal.

On the other hand the server includes a server memory of identification data of persons corresponding to the names as reference data; and a server communicator that receives the identification data of the person corresponding to the name of the person as reference data from the mobile user terminal for storage, and transmit the identification data of the person corresponding to the name of the person as reference data to another mobile user terminal for sharing the identification data of the same person corresponding to the name of the same person between the mobile user terminals for the purpose of increasing accuracy and efficiency of the personal identification.

According to a detailed feature of the preferred embodiment of this invention, the first acquisition unit includes an acquisition unit of voice print of a person, and in more detail, the first acquisition unit includes a microphone to pick up real voice of the person including the voice print, or a phone function on which voice of the person including the voice print is received.

According to another detailed feature of the embodiment of this invention, the first acquisition unit includes an acquisition unit of face features of a person, and in more detail, the acquisition unit of face features of the person a camera to capture a real face of the person including face features of the person, or a video phone function on which image of face of the person including the face features is received.

According to still another detailed feature of the embodiment of this invention, the second acquisition unit includes an optical character reader to read characters of the name of a person, or an extraction unit to extract name information from a voice of a person as the linguistic information.

According to another detailed feature of the embodiment of this invention, the display includes a visual display and/or an audio display. In more detail, the mobile user terminal further includes a microphone to pick up a voice of the person, and wherein the audio display audibly outputs the name of the person during a blank period of conversation when the voice of the person is not picked up by the microphone. Or, the audio display includes a stereo earphone, and wherein the audio display audibly outputs the name of the person only from one of a pair of channels of stereo earphone.

Further, according to another detailed feature of the embodiment of this invention, the mobile user terminal includes a cellular phone, or an assist appliance, or a combination of a cellular phone and assist appliance. An example of the assist appliance is a hearing aid, or spectacle having visual display.

Still further, according to another detailed feature of the embodiment of this invention, the server further including a reference data controller that allows the server communicator to transmit the identification data of the person corresponding to the name of the same person as reference data, which has been received from a first user terminal, to a second user terminal on the condition that the same person has given a self-introduction both to a user of the first user terminal and a user of the second user terminal to keep privacy of the same person against unknown persons. In more detail, the reference data controller is configured to allow the server communicator to transmit the identification data of the person corresponding to the name of the same person as a personal identification code without disclosing the real name of the person.

1. A data control system for a data server and a plurality of mobile user terminals comprising:
a mobile user terminal including:
a terminal memory that stores a plurality of distinguishing data for distinguishing one of a plurality of persons from the others, respectively; and
a terminal communicator that transmits one of the plurality of distinguishing data in the terminal memory to outside of the mobile user terminal, and receives another of a plurality of distinguishing data from outside of the mobile user terminal to store the received distinguishing data into the terminal memory, and
a data server including:
a server memory that stores a plurality of the distinguishing data from the plurality of mobile user terminals;
a delivery controller that supposes whether or not a first person using the mobile user terminal is acquainted with a second person using another mobile user terminal; and
a server communicator that receives the distinguishing data from the plurality of mobile user terminals for storage into the server memory, and delivers the distinguishing data of the first person to the another mobile user terminal for sharing the distinguishing data of the first person if the delivery controller supposes that the first person is acquainted with the second person, and does not deliver the distinguishing data of the first person to the another mobile user terminal if the delivery controller supposes that the first person is not acquainted with the second person.

2. The data control system according to claim 1, wherein the distinguishing data is voice print of a person.

3-4. (canceled)

5. The data control system according to claim 1, wherein the distinguishing data is face features of a person.

6-7. (canceled)

8. The data control system according to claim 1, wherein the distinguishing data is name of a person.

9-13. (canceled)

14. The data control system according to claim 1, wherein the mobile user terminal includes a cellular phone.

15-19. (canceled)

20. A data server in a data control system for a combination of the data server and a plurality of mobile user terminals, the data server comprising:
a memory that stores a plurality of the distinguishing data from the plurality of mobile user terminals;
a delivery controller that supposes whether or not a first person using a first mobile user terminal is acquainted with a second person using a second mobile user terminal; and
a communicator that receives the distinguishing data from a plurality of mobile user terminals for storage into the memory, and delivers the distinguishing data of the first person to a second mobile user terminal for sharing the distinguishing data of the first person if the delivery controller supposes that the first person is acquainted with the second person, and does not deliver the distinguishing data of the first person to the another mobile user terminal if the delivery controller supposes that the first person is not acquainted with the second person.

21. The data server according to claim 20, wherein the delivery controller is constructed to suppose that the first person is acquainted with the second person if the memory records a history that the first person has transmitted distinguishing feature of the second person.

22. The data server according to claim 20, wherein the delivery controller is constructed to suppose that the first person is acquainted with the second person if the memory receives such data from the first person that the second person is a conversation partner of the first person.

23. The data server according to claim 22, wherein the delivery controller is constructed to suppose that the first person is acquainted with the second person to whom name data of the first person is to be transmitted if the memory receives from the first person at least one of face data and voice print data of the second person at the same time when the second person requiring the delivery of the name data of the first person.

24. The data server according to claim 20 further comprising an identification data controller, wherein the distinguishing data is transmitted from the first mobile user terminal to the data server with a tentative identification data which is optionally attached to the distinguishing data by the first person, wherein the identification data controller is constructed to rewrite the tentative identification data into a controlled identification data, and the communicator is constructed to inform the first mobile use terminal of the controlled data.

25. The data server according to claim 24, wherein the identification data controller is constructed to rewrite the tentative identification data into an existing controlled identification data if the distinguishing data with the tentative identification data is of the same person related to distinguishing data with the existing controlled identification data in the memory.

26. The data server according to claim 24, wherein the identification data controller is constructed to rewrite the tentative identification data into a new controlled identification data if the distinguishing data with the tentative identification data does not coincide with any distinguishing data in the memory.

27. The data server according to claim 20, wherein the distinguishing data is transmitted from the first mobile user terminal to the data server with combination of a first optional identification data and a second optional identification data.

28. The data server according to claim 27 further comprising an identification data controller, wherein the identification data controller is constructed to rewrite the first optional identification data into a controlled identification data, and the communicator is constructed to inform the first mobile use terminal of the controlled data.

29. The data server according to claim 20, wherein the distinguishing data is face features of a person.

30. The data control system according to claim 20, wherein the mobile user terminal includes a cellular phone.

31. A data server in a data control system for a combination of the data server and a plurality of mobile user terminals, the data server comprising:
a memory that stores a plurality of the distinguishing data from the plurality of mobile user terminals, wherein the distinguishing data is transmitted from one of the mobile user terminals to the data server with a tentative identification data which is optionally attached to the distinguishing data by the first person using the mobile user terminal; and
an identification data controller constructed to rewrite the tentative identification data into a controlled identification data; and
a communicator that receives the distinguishing data from a plurality of mobile user terminals for storage into the memory, and informs the one of the mobile use terminals of the controlled data.

32. The data server according to claim 31, wherein the identification data controller is constructed to rewrite the tentative identification data into an existing controlled identification data if the distinguishing data with the tentative identification data is of the same person related to distinguishing data with the existing controlled identification data in the memory.

33. The data server according to claim 31, wherein the identification data controller is constructed to rewrite the tentative identification data into a new controlled identification data if the distinguishing data with the tentative identification data does not coincide with any distinguishing data in the memory.

34. The data server according to claim 31, wherein the distinguishing data is face features of a person.
